(19) United States
(12) Patent Application Publication
(10) Pub. No.: US 2016/0213152 A1
(43) Pub. Date: Jul. 28, 2016

(54) CHAIR ASSEMBLY WITH ARTICULATING ARM

(71) Applicant: HNI Technologies Inc., Muscatine, IA (US)

(72) Inventors: Jerry Zollars, Muscatine, IA (US); Nathaniel Birks, Bettendorf, IA (US); Conrad M. Marini, Woodbridge (CA); Paul Mazzotta, Etobicoke (CA)

(21) Appl. No.: 15/007,747

(22) Filed: Jan. 27, 2016

Related U.S. Application Data
(60) Provisional application No. 62/108,957, filed on Jan. 28, 2015.

(51) Int. Cl. A47C 7/54; A61G 5/12

(52) U.S. Cl. CPC A47C 7/543; A61G 5/12; A61G 2005/125

(57) ABSTRACT

A chair assembly includes a chair base, a seating portion and a plurality of arm rest assemblies configured to transition between down and upright positions. In various embodiments, the arm rest assemblies are mounted to the chair assembly such that, when appropriately positioned, the chair assembly is adapted to facilitate unobstructed side access to and from a seating area SA.

### CROSS-REFERENCE TO RELATED APPLICATION

This application claims priority to Provisional Application No. 62/108,957, filed Jan. 28, 2015, which is herein incorporated by reference in its entirety.

### BACKGROUND

Chair designs can impact a seated user's experience. This is especially true for healthcare patients. In such instances, designs that address not only the patient's comfort and mobility, but also meet the healthcare provider's needs are desirable. Although various chair designs have been proposed, improvements remain to be realized.

### SUMMARY

Although some features and advantages are described above, a variety of additional or alternative features and advantages are contemplated. While multiple embodiments are disclosed, still other invention embodiments will become apparent to those skilled in the art from the following detailed description, which shows and describes illustrative embodiments—embodiments that are to be regarded as illustrative in nature and not restrictive.

### BRIEF DESCRIPTION OF THE DRAWINGS

FIG. 1 is a top perspective view of a chair, according to some embodiments.

FIG. 2 is a bottom perspective view of a chair, according to some embodiments.

FIG. 3 is a bottom view of a chair, according to some embodiments.

FIG. 4 is a front view of a chair, according to some embodiments.

FIGS. 5 and 6 are side views of a chair, according to some embodiments.

FIG. 7 is a back view of a chair, according to some embodiments.

FIG. 8 is a top view of a chair, according to some embodiments.

FIG. 9 is a top perspective view of a chair, according to some embodiments.

FIG. 10 is a front view of a chair, according to some embodiments.

FIGS. 11 and 12 are side views of a chair, according to some embodiments.

FIG. 13 is a back view of a chair, according to some embodiments.

FIG. 14 is top view of a chair, according to some embodiments.

FIG. 15 is a perspective view of an arm rest assembly of the chair, according to some embodiments.

FIG. 16 is an exploded view of an arm rest assembly of the chair, according to some embodiments.

FIGS. 17 and 18 are side views of a pivot half of the arm rest assembly, according to some embodiments.

FIG. 19 is a back view of a pivot half of the arm rest assembly, according to some embodiments.

FIG. 20 is a top view of a pivot half of the arm rest assembly, according to some embodiments.

FIGS. 21 and 22 are side views of a pivot half of the arm rest assembly, according to some embodiments.

FIG. 23 is a back view of a pivot half of the arm rest assembly, according to some embodiments.

FIG. 24 is a top view of a pivot half of the arm rest assembly, according to some embodiments.

FIG. 25A is a side view of a cantilever portion of the arm rest assembly, according to some embodiments.

FIG. 25B is a bottom view of a cantilever portion of the arm rest assembly, according to some embodiments.

FIG. 25C is a top view of a cantilever portion of the arm rest assembly, according to some embodiments.

FIG. 26 is a side view of a wafer of the arm rest assembly, according to some embodiments.

FIG. 27 is a back view of a wafer of the arm rest assembly, according to some embodiments.

FIG. 28 is a side view of a wafer of the arm rest assembly, according to some embodiments.

FIG. 29 is a front view of a wafer of the arm rest assembly, according to some embodiments.

FIG. 30 is a side view of a cantilever portion of the arm rest assembly, according to some embodiments.

FIGS. 31A and 31B are cross section view of an arm rest assembly taken along line A-A of FIG. 30, according to some embodiments.

Although some features are shown in the accompanying drawings, a variety of additional or alternative features and advantages are contemplated.

### DETAILED DESCRIPTION

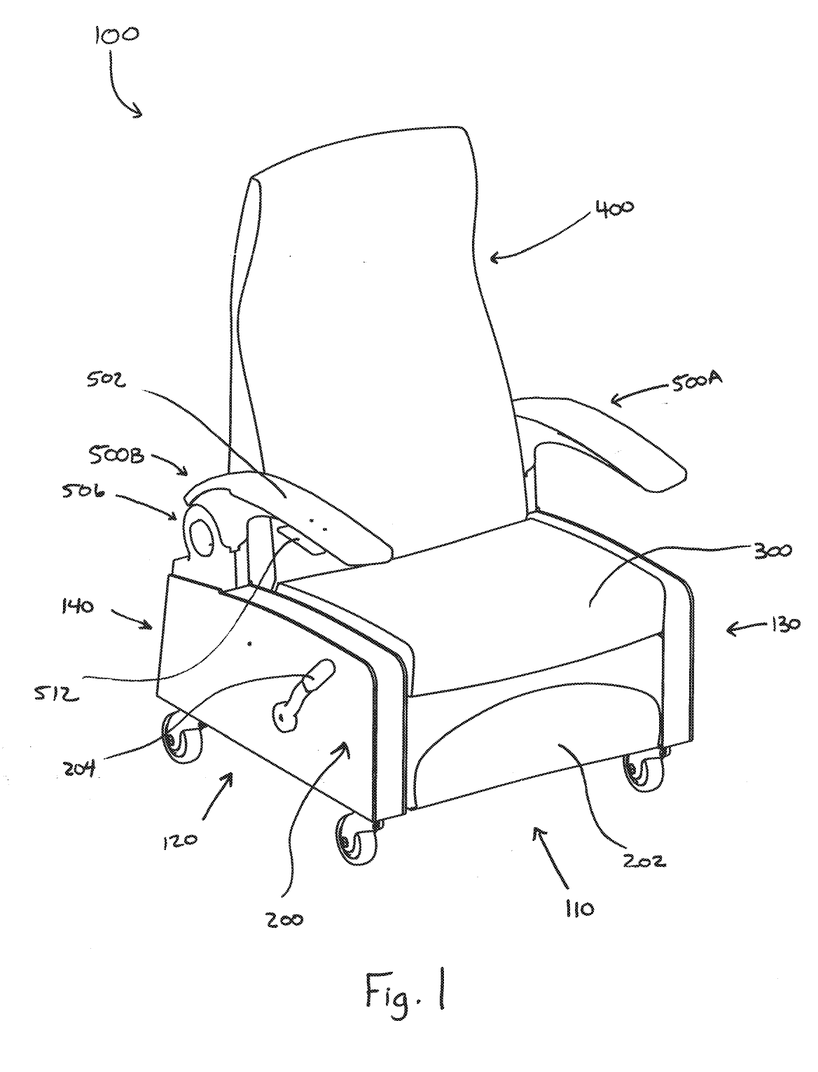

Various inventive aspects disclosed herein relate to a chair (or a patient chair) that provides for versatile and comfortable seating experience. For example, according to some embodiments, a chair 100 includes a variety of components including a chair base 200, a seating portion 300, a back support portion 400, and a plurality of arm rest assemblies 500 (such as arm rest assemblies 500A and 500B), as illustrated in FIG. 1. In various embodiments, various chair components (such as those mention above) operate together to facilitate a comfortable seating experience. The components or portions thereof are formed from a variety of materials including but not limited to foam, vinyl or other fabrics, plastic, and metal materials. In some embodiments, the various components or portions thereof are formed of cast metal, such as aluminum, iron, steel, or other materials.

With the foregoing in mind, FIG. 1 illustrates the chair 100, according to some embodiments. As shown, the chair base 200 includes a foot rest 202 for supporting a seated user's (or patient's) feet. In some embodiments, the foot rest is located on a forward side 110 of the chair base 200. In some embodiments, the foot rest 202 is operable to transition from a stowed position (FIG. 1) to extended position (not illustrated) as would be appreciated by one of ordinary skill in the art. For example, a mechanism within the chair base 200 is configured to facilitate a transition of the foot rest 202 from the stowed position to the extended position (or conversely, from the extended position to the stowed position). In the stowed position (e.g., the position illustrated in FIG. 1), the foot rest 202 and its associated mechanism is stowed within the chair base 200 such that a user (not illustrated) can easily seat him or herself in the chair 100. In other words, the stowed foot rest does not obstruct the movement of a user. In the extended position, a seated user can utilize the foot rest 202 to enjoy a relaxed and comfortable seating experience, wherein the user's legs and feet are supported by the extended foot rest 202, as would be appreciated by one of ordinary skill in the art.

In some embodiments, the foot rest 202 is activated (e.g., is transitioned from the stowed position to the extended position, or vice versa) by use of a foot rest lever arm, such as foot rest lever arm 204 illustrated in FIG. 1. In some embodiments, the foot rest lever arm 204 is incorporated into the chair base 200, and is easily accessible by a seated user (or patient). As illustrated in FIG. 1, foot rest lever arm 204 is located on the right hand side 120 of the chair base 200. However, it should be appreciated that the foot rest lever arm could be located on any suitable side of the chair base 200, such as the left hand side 130. Alternatively, the foot rest lever arm 204 may be incorporated into a chair component different from the chair base 200 (such as one of the arm rest assemblies 500).

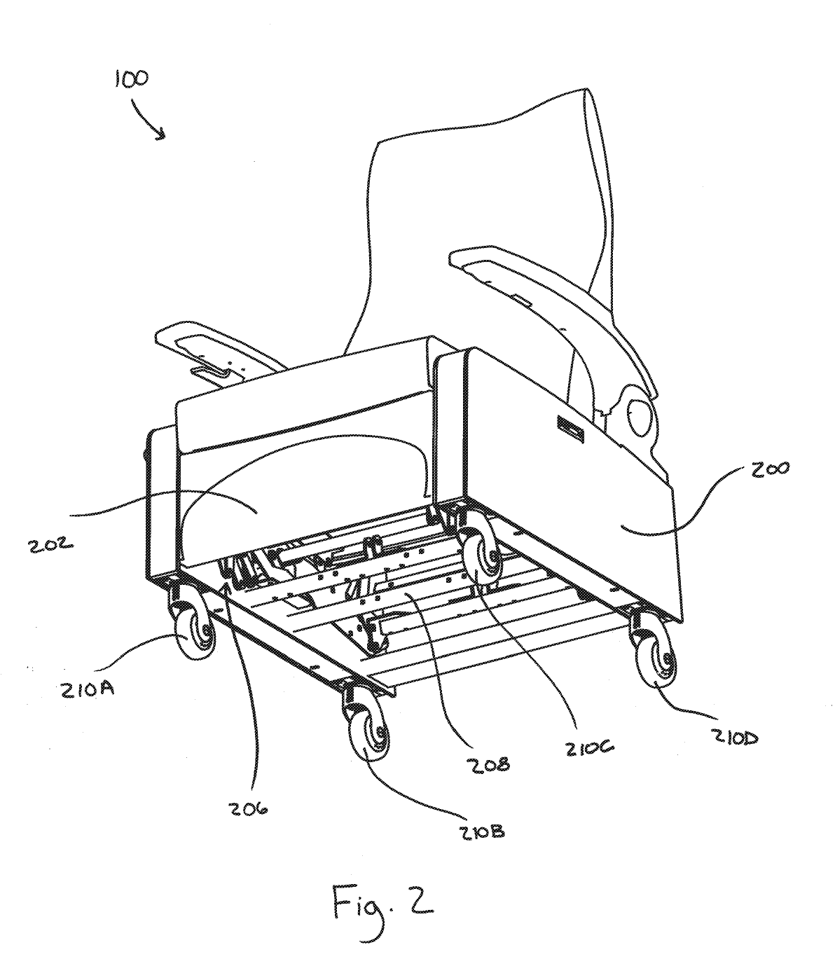

Referring now to FIG. 2, the chair base 200 includes the foot rest 202 as previously referenced and a foot rest mechanism, such as foot rest mechanism 206. In various embodiments, the foot rest mechanism 206 mechanically links the foot rest lever arm 204 with the foot rest 202. The foot rest mechanism 206 generally facilitates a transition of the foot rest 202 from the stowed position to the extended position (or from the extended position to the stowed position). In some embodiments, activation of the foot rest lever arm 204 activates the foot rest mechanism 206, as would be appreciated by one of skill in the art. It should be appreciated, however, that the foot rest 202 may be actuated by some other means, such as by applying pressure to the back support portion 400, for example. In other words, in some embodiments, reclining a back support (such as back support portion 400) may automatically actuate the foot rest from the stowed position to the extended position.

In some embodiments, the chair base 200 additionally includes one or more chair base lateral supports 208, such as chair base lateral supports 208A and 208B (FIG. 3). In some embodiments, the chair base lateral supports 208 provide the chair base 200 with structural integrity. In some embodiments, in addition to the chair base lateral supports 208, the chair base 200 additionally includes a plurality of chair base wheels 210 (such as chair base wheels 210A, 210B, 210C, and 210D). In various embodiments, the plurality of chair base wheels 210 facilitate easy repositioning of the chair 100, as would be appreciated by one of ordinary skill in the art. In some embodiments, one or more of the plurality of chair base wheels 210 include a wheel lock (not illustrated). In these embodiments, a wheel lock prevents the wheel from rotating (and thus is adapted to prevent unwanted repositioning of the chair 100).

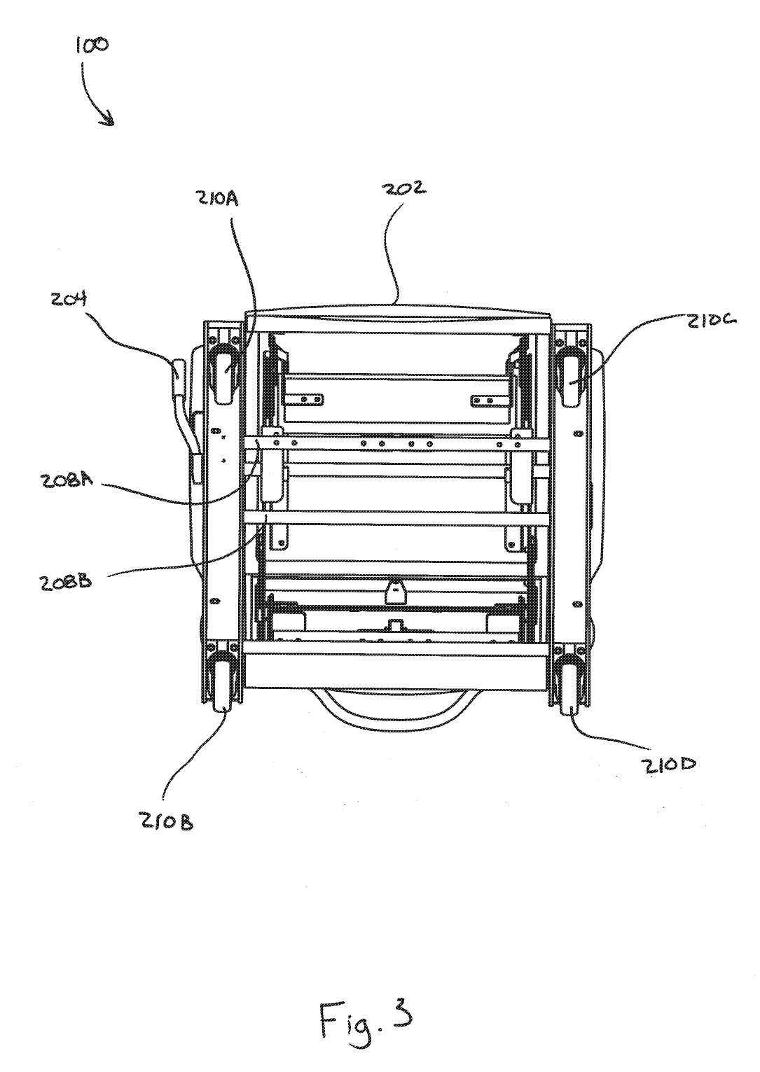

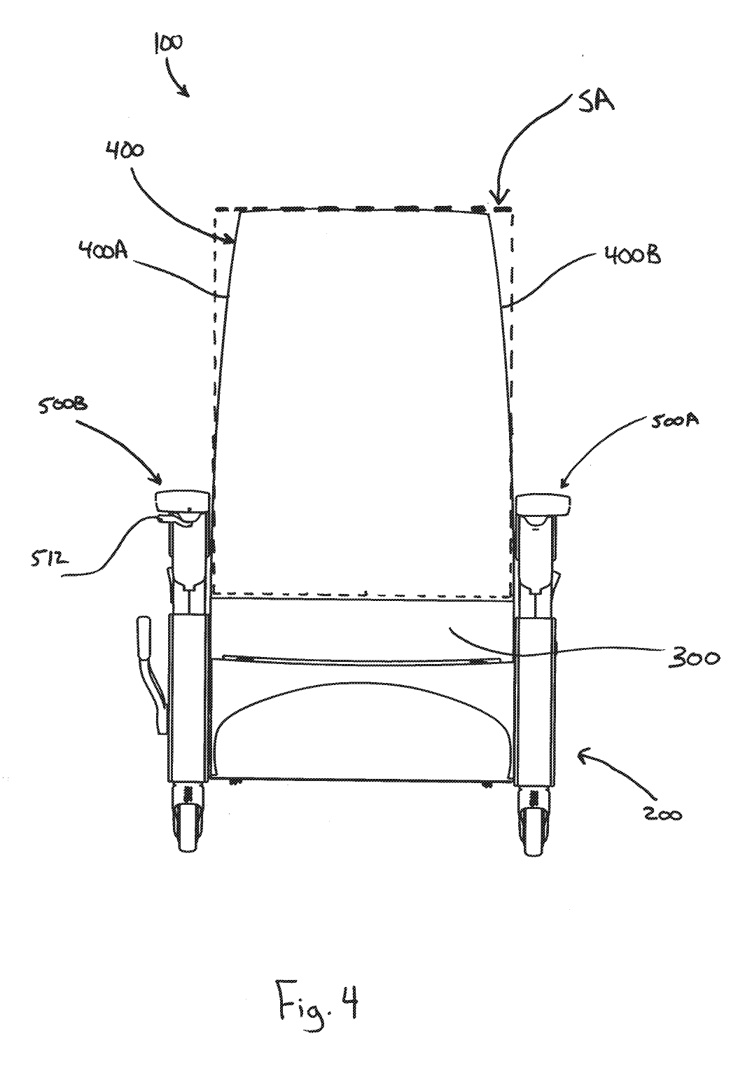

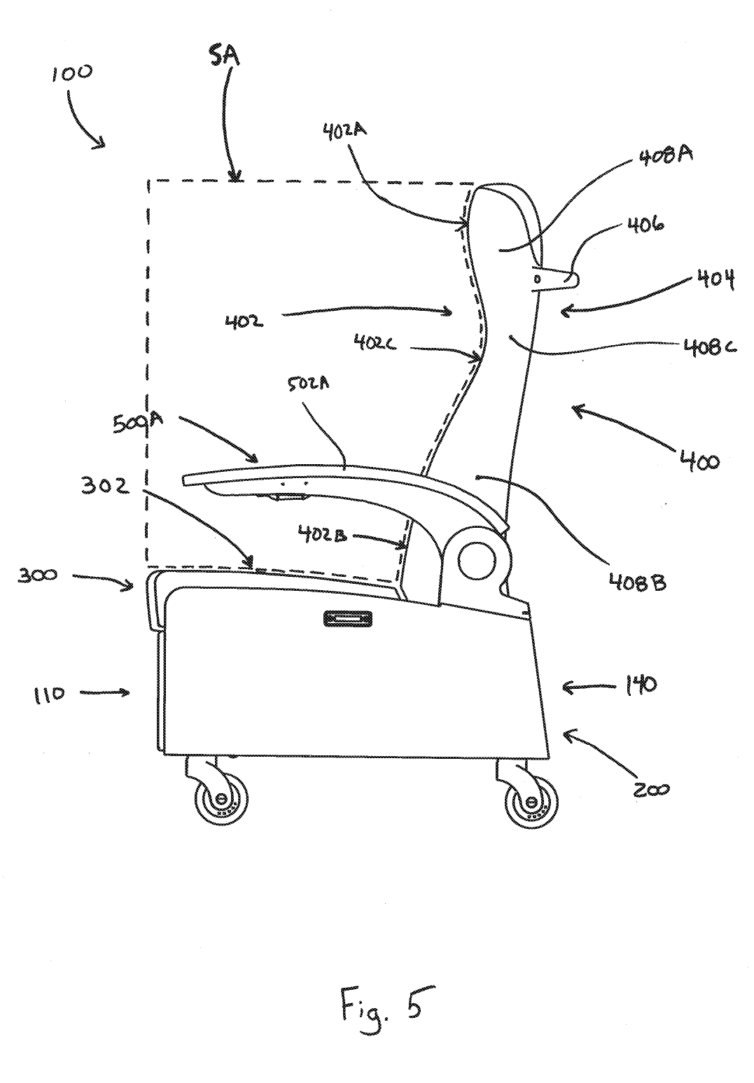

As discussed above, the chair 100 includes a seating portion 300 and a back support potion 400. For example, referring now to FIG. 4, the chair 100 includes a seating portion 300. In some embodiments, the seating portion 300 is configured to provide a comfortable seating surface 302 (FIG. 5) for a seated user (or patient). In some embodiments, the chair base 200 is adapted to receive the seating portion 300 such that the seating portion 300 is secured against unwanted movement relative to the chair base 200. In various embodiments, the seating portion 300 may be secured to the chair base 200 by one or more fasteners, as would be appreciated by one of ordinary skill in the art.

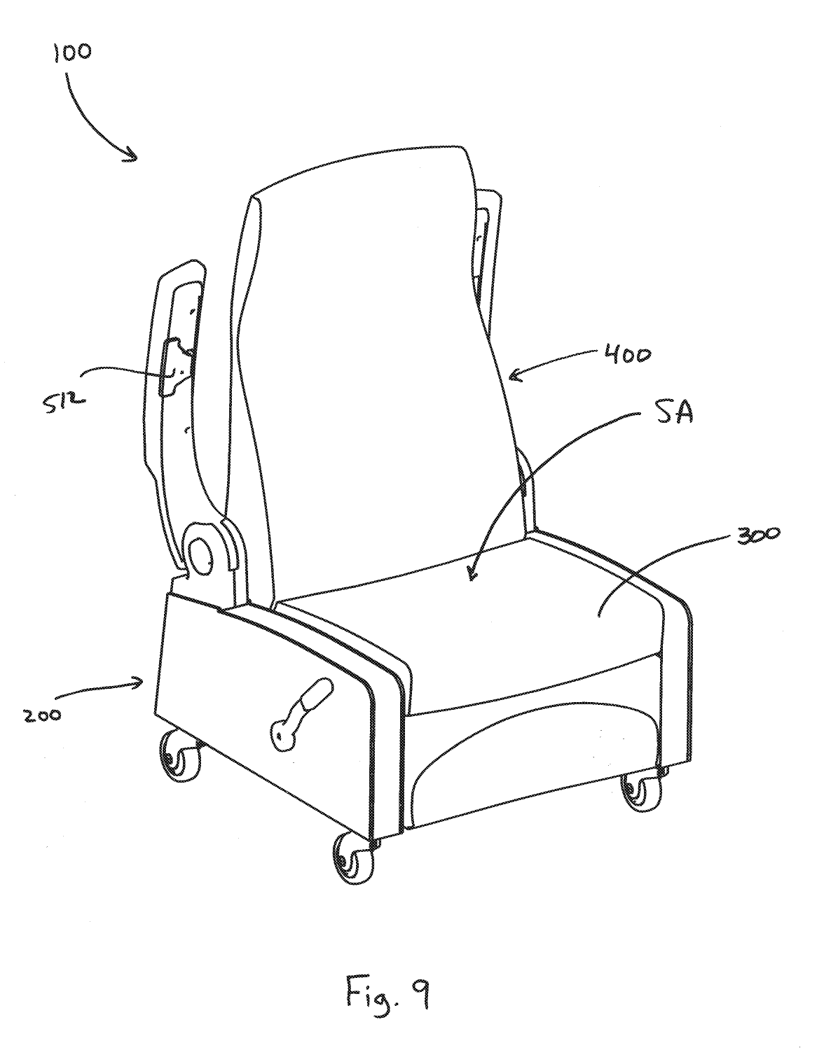

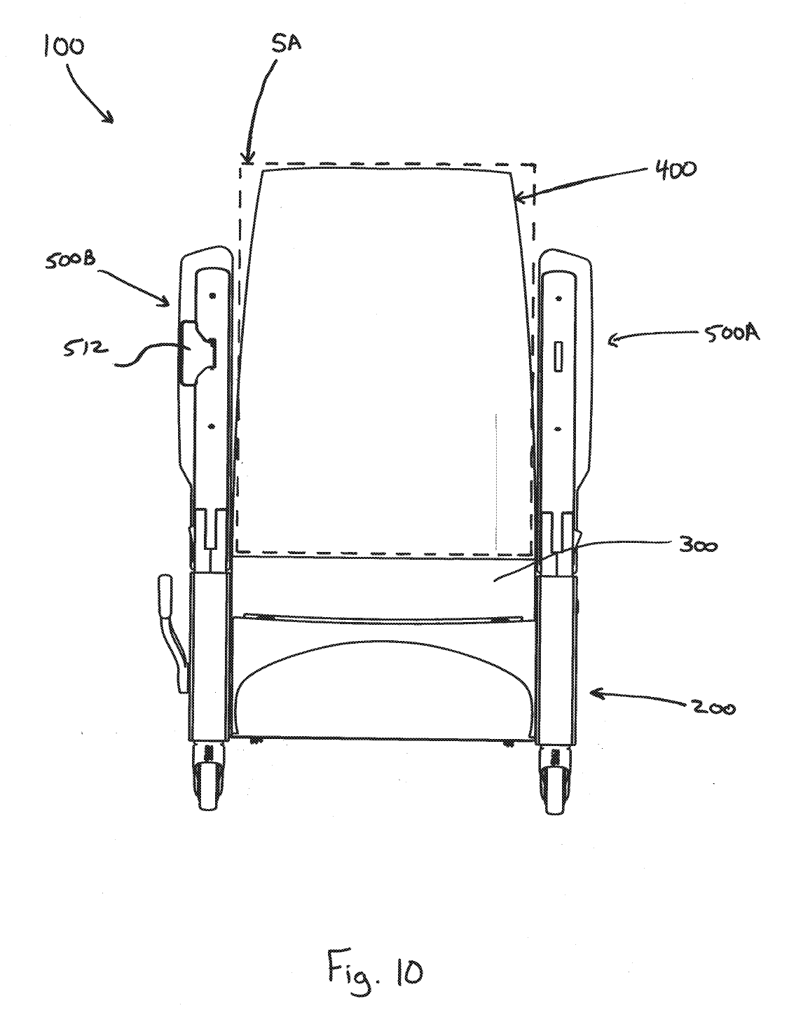

In addition, the back support portion 400 is secured to the chair base 200. The back support portion 400 is configured to provide comfort and support for a user's back when seated in the chair 100. In some embodiments, the back support portion 400 includes a right hand side 400A and a left hand side 400B. In various embodiments, the back support portion 400 is configured to comfortably receive the various shapes and contours of the seated user's back. For example, referring now to FIGS. 5, 6, and 7, the back support portion 400 includes a forward surface 402 (contoured as shown) and a rearward surface 404. In some embodiments, the back support portion 400 further includes a handle 406. In some embodiments, the contoured forward surface 402 includes an upper portion 402A, a lower portion 402B, and an intermediate portion 402C. In some embodiments, a thickness 408 of the back support portion 400 (i.e., the distance measured between the forward and rearward surfaces) varies to create the contoured forward surface 402. For example, as is illustrated in FIG. 5, the back support portion is thicker at upper portion 408A and lower portion 408B than it is at intermediate portion 408C. By varying the thickness of the back support portion 400, the back support portion 400 adopts a contoured shape that facilitates a comfortable seating experience for a user seated in the chair 100. As shown in FIGS. 4, 5, 6, 10, 11, and 12 the seating surface 302 and the forward surface 402 (in combination with certain other chair components), together, bound a seating area SA. The seating area SA is bound longitudinally by the forward surface 402 and front side 110 of the chair 100 in that the seating area includes at least a volume of space situated forward of the forward surface 402 and aft of the front side 110 of the chair 100. The seating area SA is bound laterally by armrest assemblies 500 (such as arm rest assemblies 500A and 500B discussed in greater detail below) in that the seating area SA includes at least a volume of space situated between the armrest assemblies (i.e., left of the right arm rest assembly 500A and right of the left arm rest assembly 500B) as illustrated in FIG. 4. The seating area is bound vertically by seating surface 302 and at least the upper portion 408A of the back support portion 400 in that the seating area includes at least a volume of space situated immediately above the seating surface 302 (i.e., below the cantilever portions 502) up to at least as high as the upper portion 402 of back support 400 as illustrated. As described in greater detail, according to various embodiments, the chair 100 is adapted to facilitate unobstructed side access to and from the seating area SA. It should be appreciated that facilitating unobstructed side access to and from the seating area SA is desirable because under certain circumstances it is safer and/or easier to transition a patient to the chair from another device (such as a bed, wheelchair, or other seating device). For instance, it may be difficult or dangerous to stand a patient up and seat them in a chair in a traditional manner (i.e., from a forward side of a chair, wherein the patient goes from a standing position to a seated position) as would be understood by one of skill in the art. By providing unobstructed side access to the seating area of the chair, a patient need not transition from a seated or laying position to a standing position and then back to a seated position. In any event, the embodiments disclosed herein provide for a chair that provides for independent front and side access to a seating area (i.e., multiple different independent access points).

Referring back now to FIG. 1, the chair 100 includes a plurality of arm rest assemblies 500, such as arm rest assemblies 500A and 500B. In various embodiments, the arm rest assemblies 500 include a cantilever portion 502, a mounting portion 504 (FIG. 15), and a pivot portion 506. In some embodiments, the arm rest assemblies are secured to the chair base 200 and provide support to the arms of a seated user (or patient). In some embodiments, the arm rest assemblies 500 are secured to the sides of the chair base 200, such as the right hand side 120 and the left hand side 130 of the chair base 200 (as illustrated). In the illustrated example of FIG. 1, arm rest assembly 500A is secured to left hand side 130 and arm rest assembly 500B is secured to right hand side 120. In some embodiments, the plurality of arm rest assemblies 500 are positioned toward the back side 140 of the chair base 200. For example, as seen in FIG. 1 arm rest 500B is positioned toward the back side 140 of the top, right hand side 120 of the chair base 200. Similarly, arm rest 500A is positioned toward the back side 140 of the top, left hand side 130 of the chair base 200. By positioning arm rest assemblies 500 toward the back side of either side of the chair base 200, the arm rest assemblies 500 can be secured to chair base 200 and function in accordance with chair 100 without interfering with the comfort or otherwise obstructing the mobility of a seated user. In some embodiments, the rearwardly positioned arm rest assemblies 500 facilitate unimpeded, or unobstructed side access to and from the seating area SA when transitioned from a support, or resting state to a raised, or upright state (FIG. 9).

Specifically, as discussed in greater detail below, because the arm rest assemblies 500 include a cantilever portion 502, the arm rest assembly can be mounted and oriented (via transitioning to a raised, or upright state) such that one of or both of the arm rest assemblies 500 remain free from obstructing the user's comfort and mobility. Conversely, the cantilever portion 502, when oriented in a support or resting down position, of each arm rest assembly 500 sufficiently supports an arm of the seated user (or patient). Moreover, by mounting the arm rest assemblies 500 according to such a configuration, upon orienting the cantilever portion 502 in an upright position (discussed in greater detail below), the entire arm rest assembly 500 (including the cantilever portion 502, the mounting portion 504 and the pivot portion 506) is free from interfering with the user's mobility while seated in the chair 100.

In some embodiments, as mentioned above, the arm rest assemblies 500 are configured to transition between a plurality of different positions, including an upright position and a down position. In the down position, such as the position illustrated in FIG. 1, the arm rest assemblies are operable to provide support for a seated user's arms. That is, in the down position, the cantilever portion 502 extends from the mounting portion 504 toward a front side 110 of the chair 100 such that the cantilever portion 502 is generally located adjacent to the an arm of a seated user (or patient). On the other hand, when oriented in the upright position, the arm rest assemblies 500 (including the cantilever portion 502, the mounting portion 504, and the pivot portion 506) are free from interfering with the area within which the user is seated. Accordingly, when oriented in the upright position, the cantilever portion 502 of an arm rest assembly 500 is not generally located adjacent to an arm of a seated user. An illustration of the arm rest assemblies 500 oriented in the upright position is depicted in FIGS. 9 to 14.

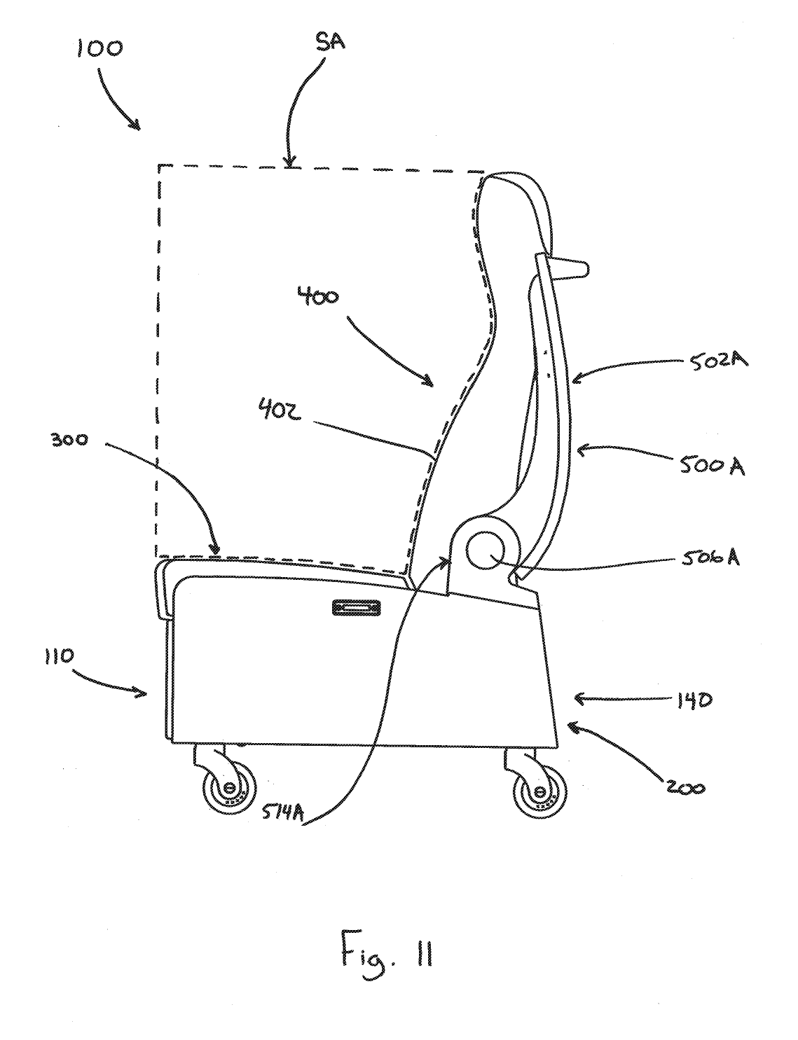

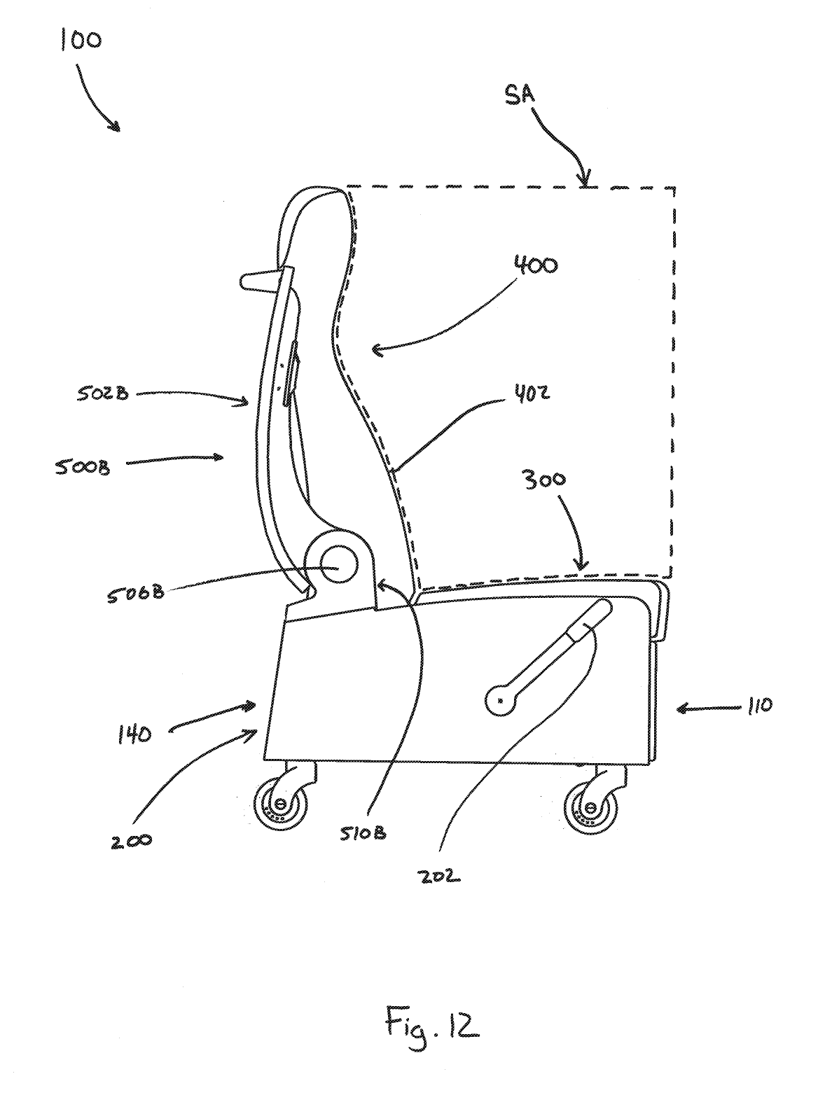

Referring now to FIG. 11, when oriented in the upright position, arm rest assembly 500A is positioned behind the contoured forward surface 402 of the back support portion 400. For example, in the illustrated example of FIG. 11, forward surface 514A of the arm rest assembly is positioned closer to the back side 140 of the chair base 200 than the forward surface 402 of the back support portion 400 is to the back side 140 of the chair base 200. Thus, the cantilever portion 502A, the mounting portion 504A, and the pivot portion 506A of the arm rest assembly 500A are each located closer to the back side 140 of the chair base 200 than the forward surface 402 of the back support portion 400. Put differently, the forward surface 402 is closer to the front side 110 of the chair base 200 than the arm rest assembly 500A. Accordingly, the arm rest assembly 500A does not interfere with (or otherwise obstruct) the mobility and comfort of a seated user, and further facilitates unobstructed side access to and from the seating area SA. Similarly, with reference to FIG. 12, when oriented in the upright position, arm rest assembly 500B (including the cantilever portion 502B, the mounting portion 504B, and the pivot portion 506B) is positioned behind the forward surface 402 of the back support portion 400. For example, forward surface 510B of arm rest assembly 500B is positioned closer to the back side 140 of the chair base 200 than the forward surface 402 of the back support portion 400 is to the back side 140 of the chair base 200. Such a configuration provides for a chair including a plurality of supporting arm rest assemblies wherein the arm rest assemblies can be repositioned such that they are free from interfering with the mobility and comfort of a seated user (or patient). Such a configuration facilitates unobstructed side access to and from the seating area SA.

On the other hand, referring back now to FIG. 5, when oriented in the down position, the cantilever portion 502A extends away from the back support portion 400 toward a front side 110 of the chair 100 such that the cantilever portion 502A is generally located adjacent to the an arm of a seated user. Similarly, with reference to FIG. 6, when oriented in the down position, the cantilever portion 502B extends away from the mounting portion 504B toward a front side 110 of the chair 100 such that the cantilever portion 502B is generally located adjacent to the an arm of a seated user. Such a configuration provides that the arm rest assemblies 500, when oriented in the down position, provide sufficient support and comfort to seated users (or patients). Moreover, such a configuration provides seated users the option to select whether or not to utilize the arm rests 500.

Referring now to FIG. 15, as discussed above, the arm rest assemblies 500 each include a mounting portion 504 for mounting the arm rest assembly 500 to the chair base 200. In some embodiments, the mounting portion 504 includes a plurality of apertures 508 (such as apertures 508A, 508B, 508C, and 508D) for fastening together the arm rest assembly 500. Additionally, in some embodiments, the arm rest assemblies 500 include one or more mounting apertures 510 (such as mounting apertures 510A and 510B). In various embodiments, the plurality of apertures 508 facilitate the fastening together of the pivot halves (as discussed in greater detail below).

In some embodiments, the chair base 200 includes a plurality of receiving portions (not illustrated), each receiving portion being configured to receive a portion of arm rest assembly 500. In some embodiment, upon the mounting portion 504 being received by the receiving portion of the chair base 200, a plurality of fasteners (e.g., screws or pins) are utilized to secure the arm rest assembly 500 to the chair based 200. In these embodiments, the plurality of fasteners interface with the plurality of apertures 510 of the mounting portion 504 of the arm rest assembly 500.

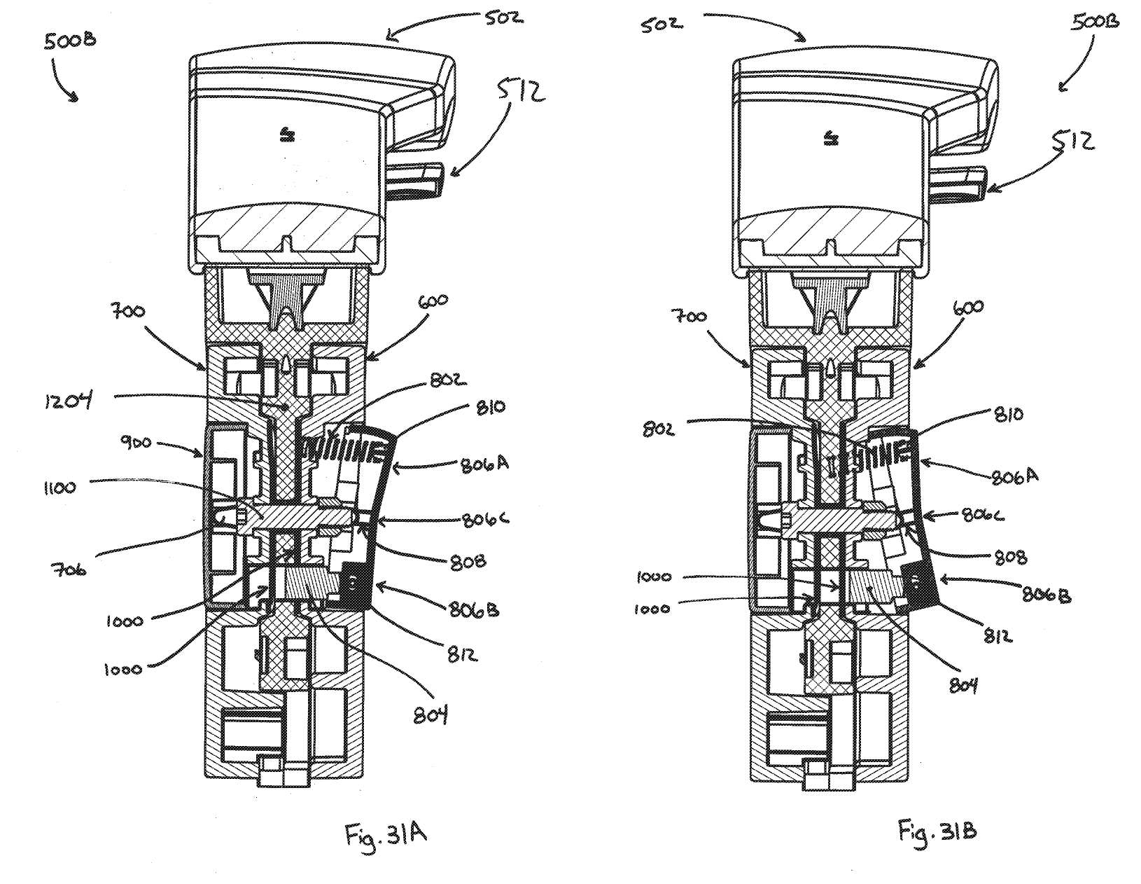

Referring now to FIG. 16, in some embodiments, in addition to cantilever portion 502, the arm rest assembly 500 is comprised of a right pivot half 600, a left pivot half 700, a pivot activation feature 800, a cover plate 900, and plurality of wafers 1000. In some embodiments, the pivot activation feature 800 includes a pivot activation feature spring 802, an arm rest position securing feature 804, and a pivot half retaining feature 808 (FIGS. 31A and 31B).

In some embodiments, the pivot halves 600 and 700 are configured to interface with the plurality of wafers 1000, the cantilever portion 502, and the pivot activation feature 800 to facilitate operation of the arm rest assembly 500. That is, the various components of the arm rest assembly 500 work together to facilitate transitioning of the cantilever portion 502 from a down position to an upright position (as mentioned above). Referring now to FIG. 17, an exterior structure of the right pivot half 600 is illustrated. In some embodiments, the right pivot half 600 includes a pivot activation feature recess 602 which is configured to receive the pivot activation feature 800. Within the pivot activation feature recess 602 is a plurality of fulcrum features 604 and 606, a spring locating feature 608, an arm rest assembly aperture 610, and an a pivot activation aperture 612.

In some embodiments, fulcrum features 604 and 606 are each configured to interface with the pivot activation feature 800 to facilitate pivoting of the pivot activation feature 800 about the fulcrum features 604 and 606. In some embodiments, the fulcrum features 604 and 606 each have a circular cross section and are additionally configured to facilitate retention of the pivot activation feature 800 within the pivot activation feature recess 602. For example, in some embodiments, the pivot half retaining feature 808 (FIGS. 31A and 31B) of the pivot activation feature 800 is configured to snap onto (or otherwise interface with) the fulcrum features 604 and 606 of the right pivot half 600 in a manner that facilitates retention of the pivot activation feature 800 within the pivot activation feature recess 602 as would be understood by one of ordinary skill.

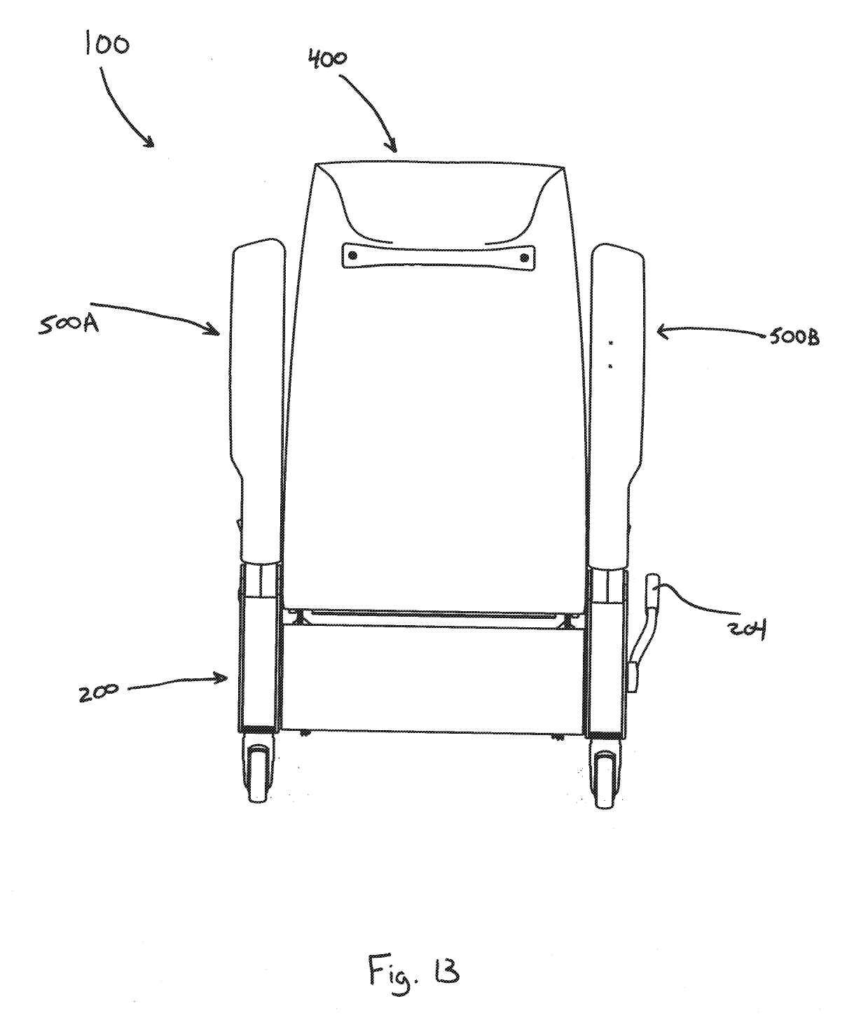

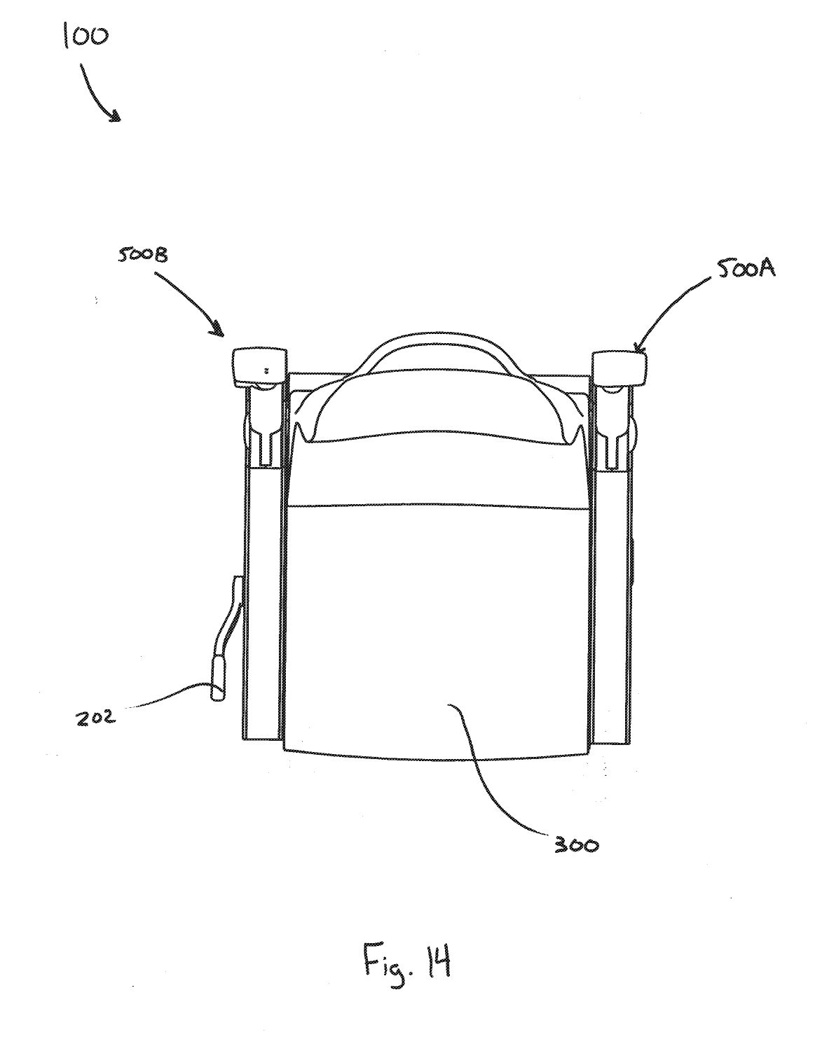

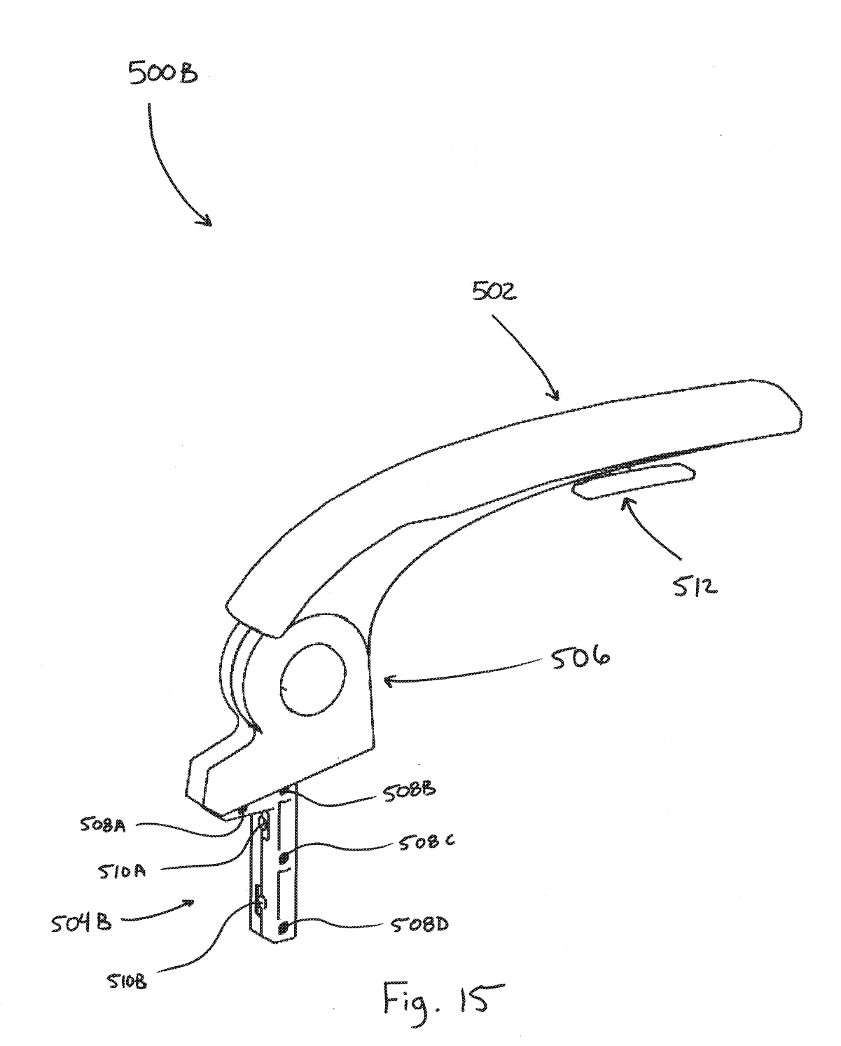

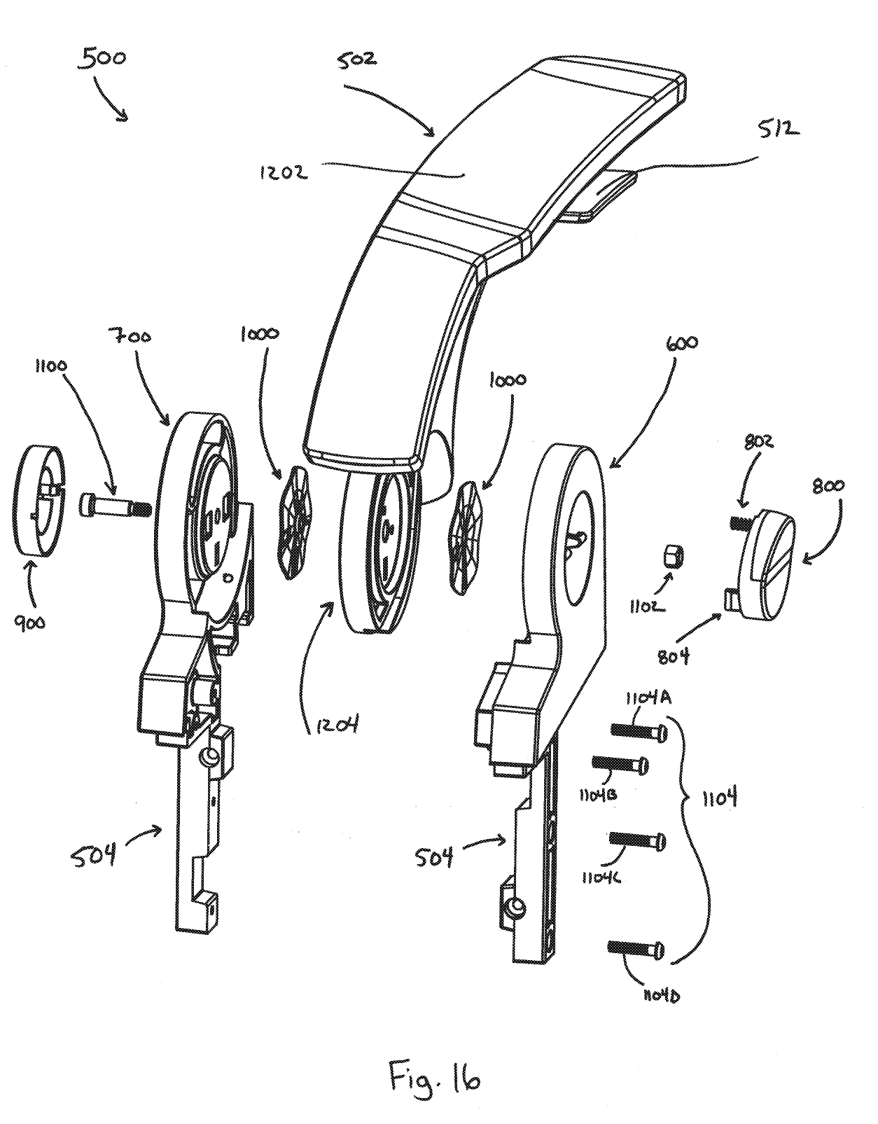

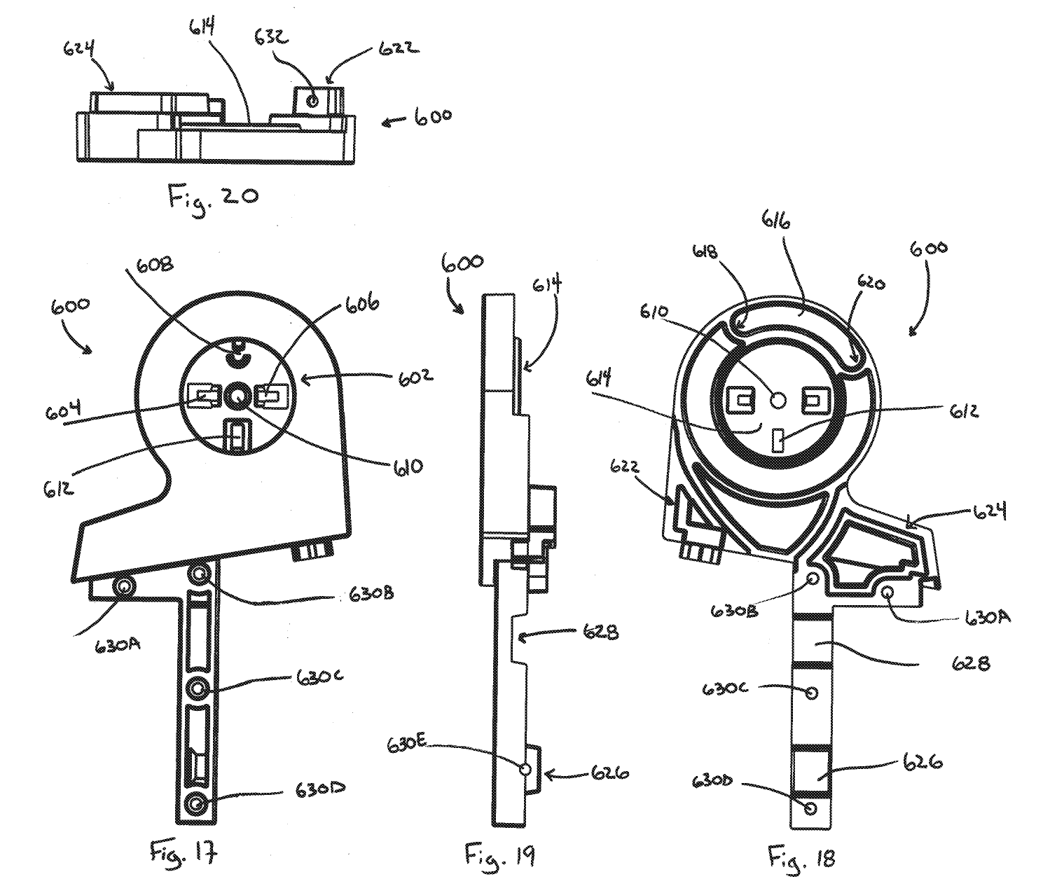

Referring now to FIG. 18, the interior structure of the right pivot half 600 is illustrated. In some embodiments, the right pivot half 600 includes a wafer interface surface 614. In some embodiments, wafer interface surface 614 is generally smooth and flat and dynamically interacts with the wafer 1000. For example, as the cantilever portion 502 of the arm rest assembly 500 transitions between down and upright positions (or vice versa), the wafer 1000 rotates (as discussed in greater detail below) while the right pivot half 600 remains static. That is, during transition of the cantilever portion 502, the wafer 1000 rotates relative to the wafer interface surface 614 of the right pivot half 600. Accordingly, during transition of the cantilever portion 502, the wafer 1000 dynamically interacts with wafer interface surface 614.

In some embodiments, the right pivot half 600 additionally includes an arced recess 616, which is configured to facilitate a limitation of the degree of rotation of the cantilever portion 502 during down and upright transitioning. Specifically, arced recess 616 includes a plurality of end portions 618 and 620. In some embodiments, the arm rest assembly 500 includes a position limit feature such as a dowel pin rigidly affixed to the cantilever portion 502 (discussed in greater detail below), which may be received by and slide within arced recess 616. Accordingly, during transition of the cantilever portion 502, the position limit feature slides within arced recess 616 and end portions 618 and 620 interact with the position limit feature of the cantilever portion 502 to prevent the cantilever portion 502 from over-rotating. In some embodiments, the arc angle of the arced recess 616 is within a range of 85 to 90 degrees (such as 87 degrees, for example). However, in other embodiments, the arc angle of the arced recess 616 is outside of the range of 85 to 90 degrees (such as 95, or alternatively 80 degrees, for example).

In various embodiments, the right pivot half 600 includes a plurality of interface features that are configured to interface with left pivot half 700. For example, as is illustrated in FIGS. 18 to 20, the right pivot half includes a first interface protrusion 622, a second interface protrusion 624, a third interface protrusion 626, and a first interface recess 628.

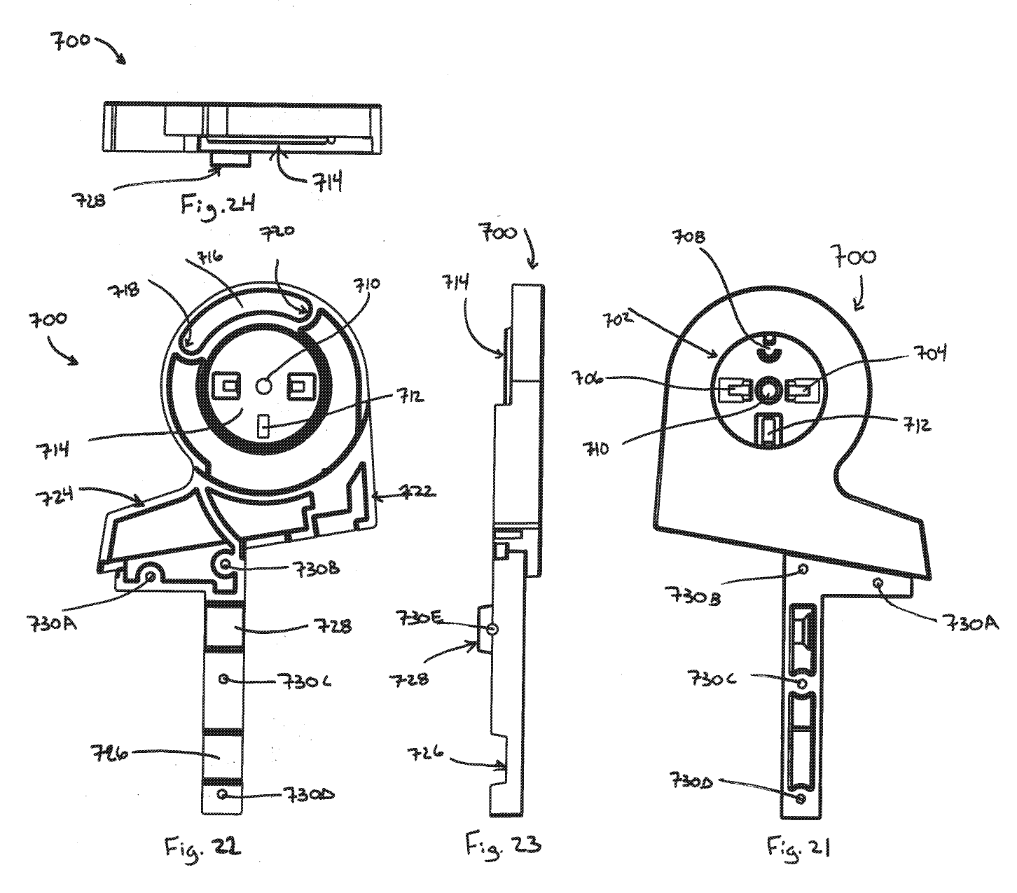

In various embodiments, the left pivot half 700 includes a plurality of interface features that are configured to interface with right pivot half 600. For example, referring now to FIGS. 21 to 23, the right pivot half includes a first interface recess 722, a second interface recess 724, a third interface recess 726, and a first interface protrusion 728. In some embodiments, interface recesses 722, 724, and 726 of left pivot half 700 are configured to receive interface protrusions 622, 624, and 626 of right pivot half 600. Additionally, first interface recess 628 of right pivot half 600 is configured to receive first interface protrusion 728 of left pivot half 700. Incorporating a plurality of interfacing features into pivot halves 600 and 700 provides for a more secure and robust arm rest assembly 500.

In some embodiments, the interior structure of the left pivot half 700 is similar to the interior structure of right pivot half 600. For example, as is illustrated in FIG. 21, the left pivot half 700 includes a wafer interface surface 714 (similar to wafer interface surface 614 of right pivot half 600). In some embodiments, wafer interface surface 714 is generally smooth and flat and dynamically interacts with a second wafer 1000 (see FIG. 16). For example, as the cantilever portion 502 of the arm rest assembly 500 transitions between down and upright positions (or vice versa), the wafer 1000 rotates while the left pivot half 700 remains static. That is, during transition of the cantilever portion 502, the wafer 1000 rotates relative to the wafer interface surface 714 of the left pivot half 700. Accordingly, during transition of the cantilever portion 502, the wafer 1000 dynamically interacts with wafer interface surface 714 (similar to the interaction between the other wafer 1000 and the wafer interface surface 614).

In some embodiments, the left pivot half 700 additionally includes an arced recess 716 (similar to arced recess 616 of right pivot half 600). In some embodiments, arced recess 716 is configured to limit the amount of rotation of the cantilever portion 502 during transition between down and upright positioning. Specifically, arced recess 716 includes a plurality of end portions 718 and 720 (similar to end portions 618 and 620 of right pivot half 600). In some embodiments, the position limit feature of cantilever portion 502 (discussed above) may be additionally or alternatively received by and slide within arced recess 716. Accordingly, during transition of the cantilever portion 502, the position limit feature additionally or alternatively slides within arced recess 716 and end portions 718 and 720 interact with the position limit feature of the cantilever portion 502 to prevent the cantilever portion 520 from over-rotation. In some embodiments, the arc angle of the arced recess 716 is within a range of 85 to 90 degrees (such as 87 degrees, for example). However, in other embodiments, the arc angle of the arced recess 716 is outside of the range of 85 to 90 degrees. It should be appreciated that the position limit feature (such as the dowel pin mention above) may only interact with one of the left side or the right side.

Referring now to FIG. 21, an exterior structure of the left pivot half 700 is illustrated. In some embodiments, the exterior structure of the left pivot half is similar to the exterior structure of the right pivot half 600. For example, as is illustrated in FIG. 24, the right pivot half 700 includes a pivot activation feature recess 702 (similar to pivot activation feature recess 602). Within the pivot activation feature recess 702 is a plurality of fulcrum features 704 and 706 (similar to fulcrum features 604 and 606), a spring locating feature 708 (similar to spring locating feature 608), an arm rest assembly aperture 710 (similar to arm rest assembly aperture 610), and an a pivot activation aperture 712 (similar to pivot activation aperture 612). By incorporating common features into pivot halves 600 and 700, the arm rest assembly 500 gains versatility. For example, because the exterior structure of left and right pivot halves is similar, pivot activation feature 800 can properly interface with pivot activation feature recesses 602 or 702 without modification of pivot halves 600 and 700 and without modification of pivot activation feature 800, according to some embodiments. Put differently, the configuration facilitates universal application of arm rest assembly 500 to either side (left or right) of the chair 100. Such a configuration and universal applicability reduces the number of components and cost of manufacture.

In some embodiments, in addition to receiving pivot activation feature 800, pivot activation feature recesses 602 and 702 can each alternatively receive cover plate 900. That is, similar to pivot activation feature 800, cover plate 900 may interface with either of pivot halves 600 and 700, according to some embodiments.

Referring now to FIGS. 25A to 25C, the cantilever portion 502 includes an arm support portion 1202 and a pivot half interface portion 1204. In some embodiments, the arm support portion 1202 is contoured to provide a comfortable surface upon which a seated user (or patient) may rest his arm. In some embodiments, the arm support portion 1202 extends away from the pivot half interface portion 1204.

In various embodiments, as is illustrated in FIG. 25B, the pivot half support portion 1204 includes a plurality of sides (1204A and 1204B), which are mirror images of one another. Accordingly, while a description is given only with respect to side 1204A, it should be appreciated that side 1204B includes similar features. Referring back now to FIG. 25A, pivot half interface portion 1204 includes a wafer interface surface 1206A, a plurality of wafer retaining reliefs 1208A and 1210A, an arm rest assembly aperture 1214, a down position aperture 1216, an upright position aperture 1218, and a position limit feature relief 1220.

In various embodiments the wafer interface surface 1206A is generally flat and smooth and is configured to provide a suitable surface against which wafer surface 1002 of wafer 1000 may react. For example, as the cantilever portion 502 of the arm rest assembly 500 transitions between down and upright positions (or vice versa), pivot half interface portion 1204 (and thus wafer interface surface 1206A) rotate. Similarly, as discussed in greater detail below, because wafer 1000 includes wafer protrusions 1006 and 1008 (which are received by wafer retaining reliefs 1208A and 1210A), wafer 1000 also rotates. That is, wafer 1000 and cantilever portion 502 rotate together such that there is no relative rotational movement between wafer 1000 and wafer interface surface 1206A. In various embodiments, wafer retaining reliefs 1208A and 1210A facilitate such a lack of relative rotational movement. Specifically, wafer retaining reliefs 1208A and 1210A are configured to receive wafer protrusions 1006 and 1008, respectively. Accordingly wafer protrusions 1006 and 1008 prevent the wafer 1000 from changing angular position relative to wafer interface surface 1206A, as would be understood by one of ordinary skill.

In various embodiments, down position aperture 1216 and upright position aperture 1218 are configured to receive arm rest position securing feature 804 of pivot activation feature 800 (as will be discussed in greater detail below). Specifically, while oriented in the down position with the pivot activation feature 800 disengaged, the arm rest position securing feature 804 of pivot activation feature 800 is received within (or at least a portion of pivot activation feature 800 is received within) down position aperture 1216 such that an interaction between arm rest position securing feature 804 and down position aperture 1216 prevents any rotational movement (or pivoting) of cantilever portion 502.

Moreover, while oriented in the upright position with the pivot activation feature 800 disengaged, the arm rest position securing feature 804 of pivot activation feature 800 is received within (or at least a portion of pivot activation feature 800 is received within) upright position aperture 1218 such that an interaction between arm rest position securing feature 804 and upright position aperture 1218 prevents any rotational movement (or pivoting) of cantilever portion 502.

As discussed above, in various embodiments, the arm rest assembly 500 includes a position limit feature (not shown) such as a dowel pin. In some embodiments, the position limit feature is retained within, with a portion extending beyond, position limit feature aperture 1220 such that upon assembly of the cantilever portion 502 with the pivot halves 600 and 700, the position limit feature remains retained within position limit feature aperture 1220 and the portions extending beyond are operable to slide within arced recesses 616 and/or 716 of pivot halves 600 and 700, respectively.

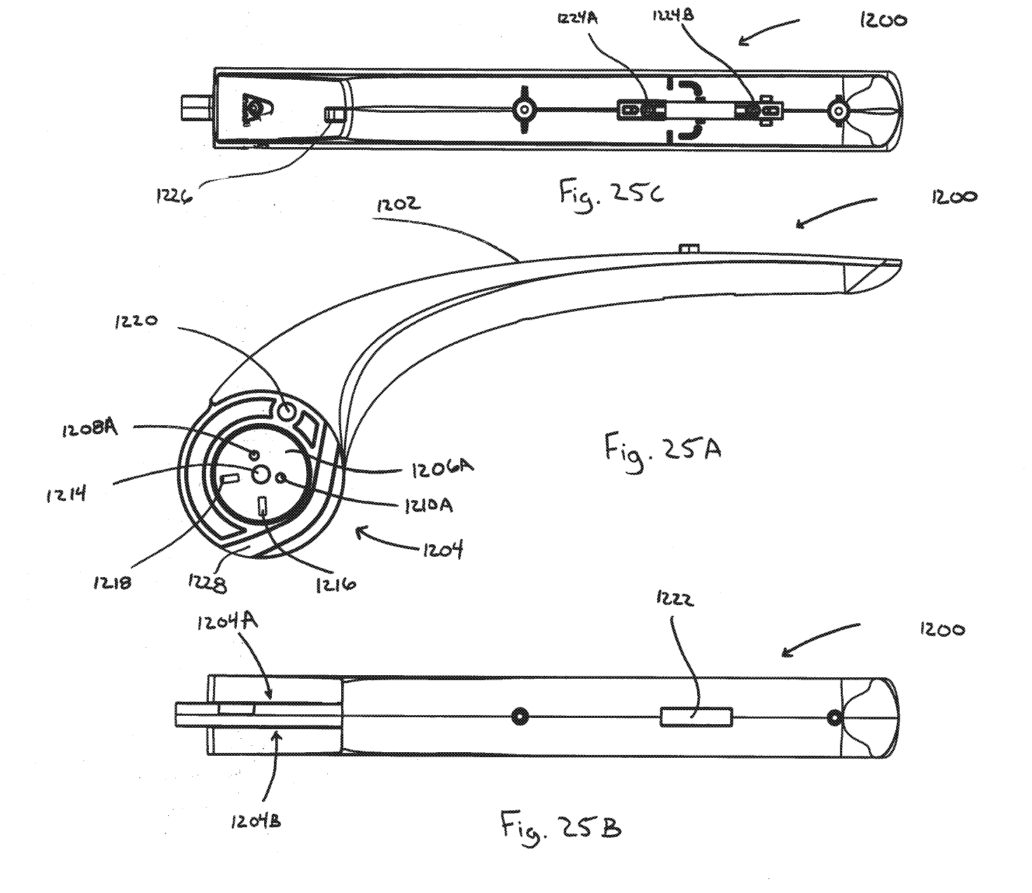

In some embodiments, as discussed above, arm rest assembly 500 includes a plurality of wafers 1000. In some embodiments, the wafers 1000 facilitate a smooth rotation of cantilever portion 502 while still providing a sufficient amount of resistance. Referring now to FIGS. 26 to 29, in some embodiments, each wafer 1000 includes a cantilever portion interface surface 1002 and a pivot half interface surface 1004. In some embodiments, cantilever portion interface surface 1002 includes a plurality of wafer protrusions, such as wafer protrusions 1006 and 1008, and a cylindrical wafer boss 1010. In some embodiments, wafer boss 1010 includes an aperture through which assembly securing feature 1100 passes upon assembly of arm rest assembly 500. As discussed above, wafer protrusions 1006 and 1008 are received within wafer protrusion reliefs (such as protrusion reliefs 1208A and 1210A) of the cantilever portion 502. In some embodiments, cylindrical wafer boss 1010 is received within arm rest assembly aperture 1214. The plurality of wafer protrusions 1006 and 1008 and cylindrical wafer boss 1010 provide for the securing of wafer 1000 against rotational movement relative to the cantilever portion 502 of the arm rest assembly 500.

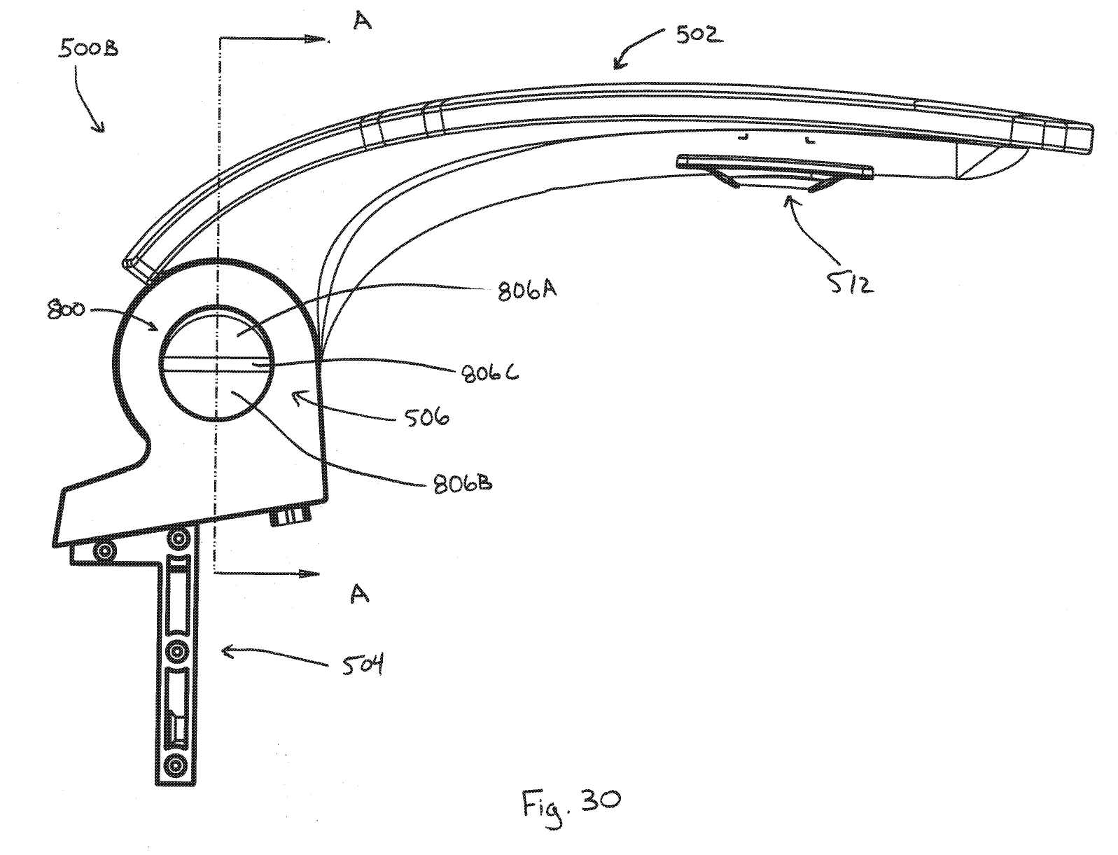

Securing wafer 1000 against rotational movement relative to cantilever portion 502 provides for an arm rest assembly 500 having a smooth pivoting cantilevered arm with a sufficient amount of rotational resistance. In some embodiments, the wafer 1000 additionally includes an arced relief (or aperture) 1012 (FIGS. 27 and 29). In some embodiments, the arced relief 1012 provides that wafer 1000 does not interfere with arm rest position securing feature 804. In some embodiments, arced relief 1012 includes a first end 1014 and a second end 1016. For example, referring back for FIG. 27, arced relief 1012 extends along an arc angle of 85 to 90 degrees. However, it should be appreciated that arced relief 1012 may extend along an arc angle outside of the range of 85 to 90 degrees (such as some arc angle in excess of 90 degrees or alternatively some arc angle less than 85 degrees) without departing from the scope of the present invention. In some embodiments, the degree of arc is configured such that wafer 1000 does not interfere with arm rest portion securing feature 804 at any point during transition or the cantilever portion 502 from a down position to an upright position (or vice versa).

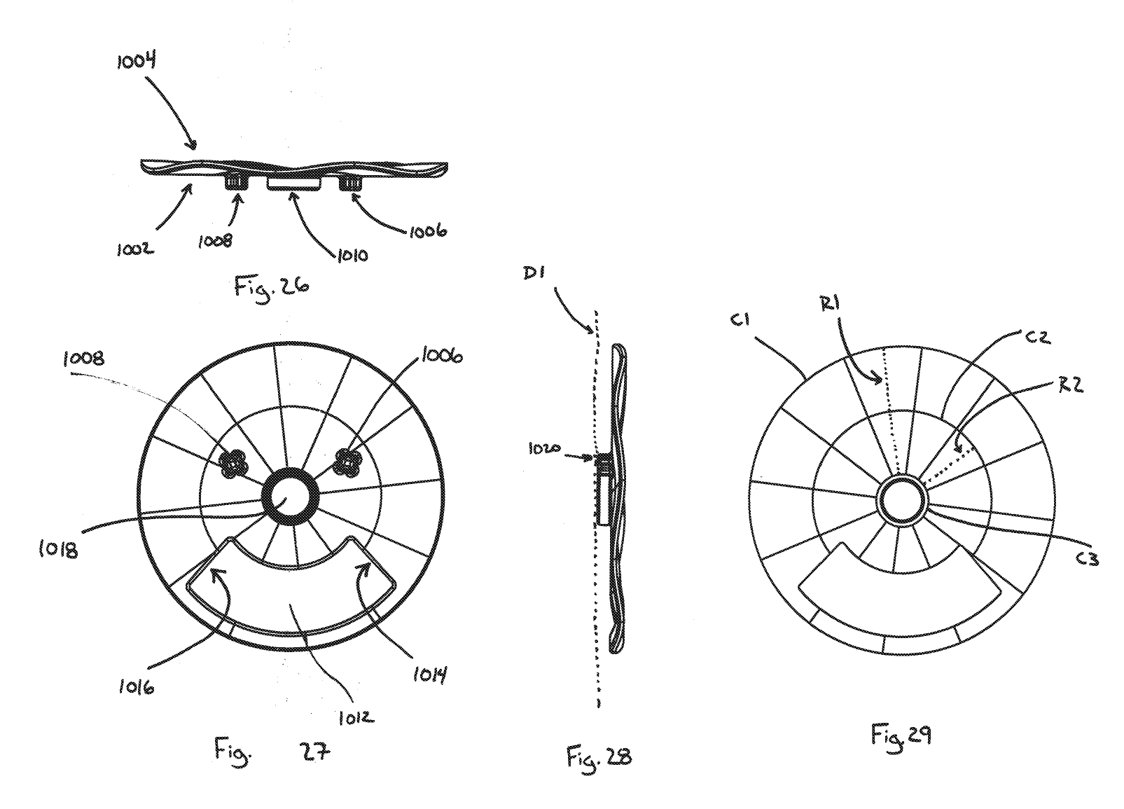

In various embodiments, one or more of interfacing surfaces 1002 and 1004 of wafer 1000 are not flat or smooth. Instead, in some embodiments, these surfaces are configured to pitch, axially, as the surface is traversed, radially (as illustrated). For example, referring now to FIGS. 28 and 29, if a datum plane D1 is established on face 1020 of cylindrical wafer boss 1010 and distance measurements are continuously taken between the circumferential perimeter and datum plane D1 as the circumferential perimeter is traversed, the distance measurements will vary (they will not be constant). In some embodiments, the interfacing surfaces 1002 and 1004 include a series of repetitious peaks and valleys. For example, as the circumferential perimeter (C1, FIG. 29) of wafer 1000 is traversed, a peak is registered at each of 0, 60, 120, 180, 240, and 300 degrees, while a valley is registered at each of 30, 90, 150, 210, 270, and 330 degrees. In other words, in some embodiments, the wafer 1000 includes a repetitious alternating pattern of peaks and valleys (such as a peak repeating every 60 degrees and a valley repeating every 60 degrees, wherein the peaks and valleys are offset from one another by 30 degrees). Accordingly, the distances measured at 0, 60, 120, 180, 240, and 300 degrees would differ from the distances measured at 30, 90, 150, 210, 270, and 330 degrees. It should be appreciated that wafer 1000 may include any number of peaks and valleys and is not limited by those embodiments discussed above.

In some embodiments, this same differential measurement pattern of peaks and valleys (with different magnitudes) would be observed if distance measurements were continuously taken along a radial path (C2) located at some radial distance between the center point and the circumferential perimeter (0<R2<R1) of the wafer 1000. In some embodiments, interface surface 1002 is generally flat at the intersection of the base of boss 1010 and interface surface 1002 (represented in FIG. 29 by radial path C3). In other words, in some embodiments, distances measurements continuously taken along radial path (C3) between C3 and datum D1 would remain constant. Conversely, distance measurements continuously taken along radial path C2 (or alternatively C1) between C2 (or alternatively C1) would vary as the radial path is traversed. Thus, the magnitude of displacement (i.e., distance between datum plane D1 and interface surface 1002) decreases (or alternatively increases) along R1 (and similarly along R2), between C1 and C3. In some embodiments, similar surface structure is observed for interface surface 1004. While this type of alternating peak and valley pattern is illustrated in association with these embodiments, in various other embodiments, other non-flat, differential surface patterns may be utilized without departing from the scope of the invention. Conversely, in some embodiments, interface surface 1002 may remain non-flat (as discussed above) while interface surface 1004 remains flat (and vice versa).

In some embodiments, wafer 1000 is comprised of a resilient, yet semi-flexible elastomeric material and may be formed by way of an injection molding process. Specifically, wafer 1000 is designed to flex under load and return to its original shape with not under load. For example, when assembled, wafers 1000 are situated between cantilever portion 502 and left and right pivot halves 600 and 700, respectively. Once assembled, the left and right pivot halves (600 and 700) are drawn together via the utilization of some retaining means (such as bolt or screw, or a series of bolts and screws), such that a compressive force is exerted upon wafers 1000 by the cantilever portion 502 and the left pivot half 700, or in the case of the other wafer 1000 (i.e., the second of the wafers 1000, FIG. 16) by the cantilever portion 502 and the right pivot half 600. In such a configuration, the compressive force exerted upon each wafer causes the wafer to deform. That is, the compressive force influences the non-flat interfacing surface(s) to approach a more flat structure. This effect causes friction between the wafers and the corresponding interfacing surfaces of the cantilever portion 502 and the pivot halves (600 or 700). As one of ordinary skill can appreciate, as the compressive force is increased, the resulting friction increases. This friction facilitates a smoothly transitioning cantilever portion 502. While the friction induces some resistance to rotation of the cantilever portion 502, one of ordinary skill would appreciate that such resistance is easily overcome by a user inducing a force sufficient to cause rotation of the cantilever portion 502. It is this interaction that creates a smooth transition of the cantilever between the upright and the down positions.

Referring now to FIG. 30, one example embodiment of arm rest assembly 500B is illustrated. In this example embodiment, arm rest assembly 500B includes cantilever portion 502, mounting portion 504, and pivot portion 506. Additionally, pivot portion 506 includes pivot activation feature 800, which includes upper section 806A and lower section 806B, and pivot section 806C. In some embodiments, the upper section 806A can be depressed by applying pressure thereto (such as, for example, in a direction coaxial with the arm rest assembly aperture 1214). The depression of upper section 806A causes pivot activation feature 800 to pivot about fulcrum features 604 and 606 of right pivot half 600. When pivot activation feature 800 is sufficiently pivoted, arm rest position securing feature 804 disengages from down position aperture 1216 of cantilever portion 502 (FIG. 25A) such that the cantilever portion 502 is free to transition from the down position to the upright position. In some embodiments, upper section 806A need only be initially depressed to facilitate the transition of the cantilever portion 502 between the down position and the upright position. In yet various other embodiments, upper section 806A may be depressed during a portion of the transition of the cantilever portion 502 between the down position and the upright position, and subsequently released during the remainder of the transition of the cantilever portion 502 between the down position and the upright position. In yet further embodiments, upper section 806A may be depressed for the entire transition of the cantilever portion 502 between the down position and the upright position, and subsequently released upon completion of the transition of the cantilever portion 502 between the down position and the upright position.

Similarly, where cantilever portion 502 is in an upright position (and arm rest position securing feature 804 is engaged with upright position aperture 1218, a user may depress upper section 806A by applying pressure thereto. The depression of upper section 806A causes pivot activation feature 800 to pivot about fulcrum features 604 and 606 of right pivot half 600. When pivot activation feature 800 is sufficiently pivoted, arm rest position securing feature 804 disengages from upright position aperture 1218 of cantilever portion 502 (FIG. 25A) such that the cantilever portion 502 is free to transition from the upright position to the down position. It should be appreciate that depression of upper section 806A in this configuration operates in a substantially similar manner to that discussed above (ex., upper section 806A may be depressed for a portion of or an entirety of the transition of the cantilever portion from the upright position to the down position).

In either event (i.e., transitioning from a down position to and upright position, or from an upright position to a down position), up removing pressure from (i.e., ceasing the depression of upper section 806A), the pivot activation feature spring 802 is configured to influence the upper section 806A away from the right pivot half 600 (as discussed above). This influence causes upper section 806A to pivot about out fulcrum features 604 and 606 of right pivot half 600 such that, when properly oriented the arm rest position securing feature 804 is free to engage one of the upright position aperture 1218 or down position aperture 1216 (as discussed below).

Referring now to FIGS. 31A and 31B, a cross section view taken along line A-A of FIG. 30 is illustrated, highlighting the interaction of various features of arm rest assembly 500B during depression of upper section 806A (and the pivoting of activation feature 800 about fulcrum features 604 and 606). For example, as is illustrated in FIG. 31A, while oriented in the down position and prior to the depression of upper section 806A of pivot activation feature 800, arm rest position securing feature 804 extends away from pivot activation feature 800 and through each of: pivot activation aperture 612 of right pivot half 600, arced relief 1012 of wafer 1000, and down position aperture 1216 of cantilever portion 502. In some embodiments, pivot activation feature spring 802 is situated between pivot activation feature 800 and spring locating feature 608 of right pivot half 600. In some embodiments, pivot activation feature 800 similarly includes a spring locating feature 810, which retains pivot activation feature spring 802 at a desired location on pivot activation feature 800. Pivot activation feature spring 802 induces a force into upper section 806A in a direction away from right pivot half 600 such that pivot activation feature 800 pivots about fulcrum features 606 and 608. This pivot action influences arm rest position securing feature 804 to adopt and maintain its position extending through each of pivot activation aperture 612 of right pivot half 600, arced relief 1012 of wafer 1000, and down position aperture 1216 of cantilever portion 502.

As discussed above, in some embodiments, upper section 806A may be depressed by applying pressure thereto. The application of pressure upon upper section 806A in a direction toward right pivot half 600 induces a force upon upper section 806A and causes compression of pivot activation feature spring 802 and causes pivot activation feature 800 to pivot about fulcrum features 604 and 606 of right pivot half 600. This pivoting action causes arm rest position securing feature 804 to be withdrawn from down position aperture 1216 of cantilever portion 502 and arced relief 1012 of wafer 1000. For example, as is illustrated in FIG. 31B, by applying a force to upper section 806A toward right pivot half 600, pivot activation feature 800 pivots about fulcrum features 604 and 606. Upon pivoting a sufficient amount, arm rest position securing feature 804 is withdrawn from down position aperture 1216 of cantilever portion 502 and arced relief 1012 of wafer 1000. The withdrawal of arm rest position securing feature 804 from the down position aperture 1216 provides for free rotation of cantilever portion 502 from the down position to the upright position. Similarly, if the cantilever portion 502 is situated in the upright position, the withdrawal of arm rest position securing feature 804 from upright position aperture 1218 provides for free rotation of cantilever portion 502 from the upright position to the down position.

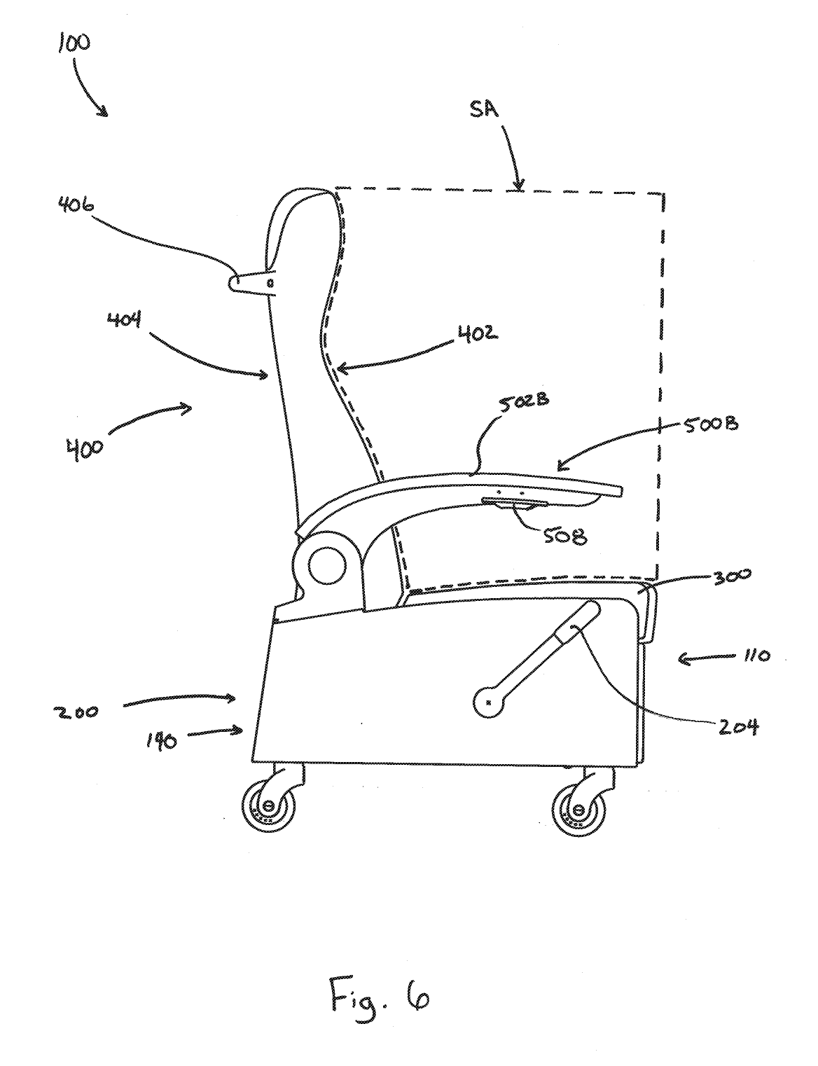

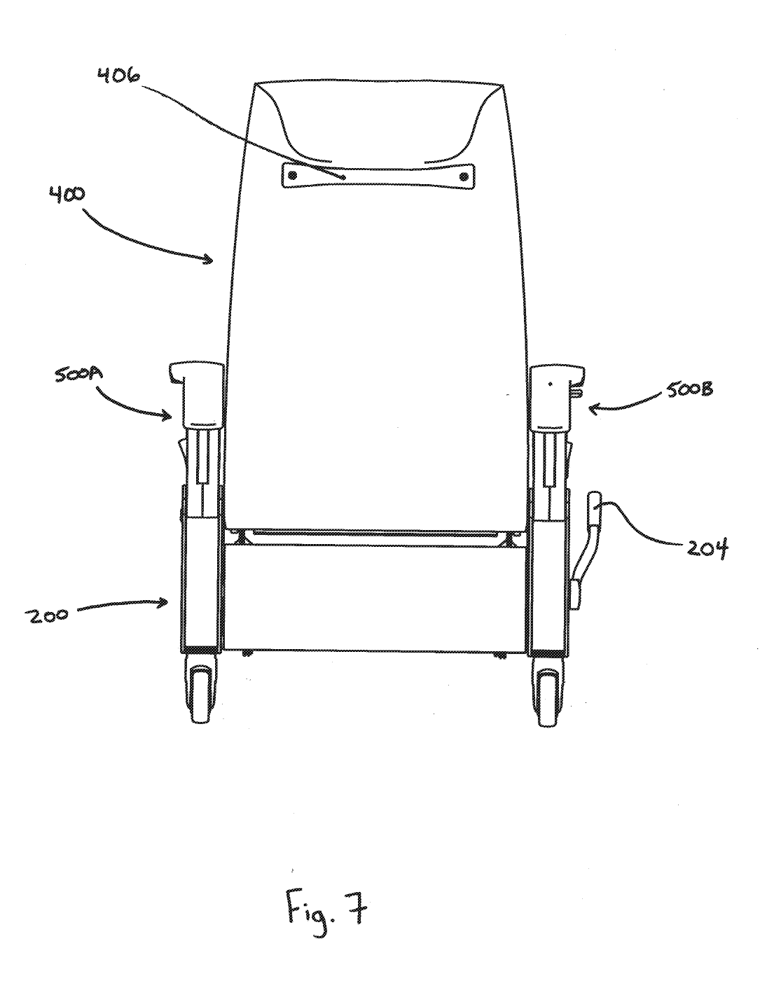

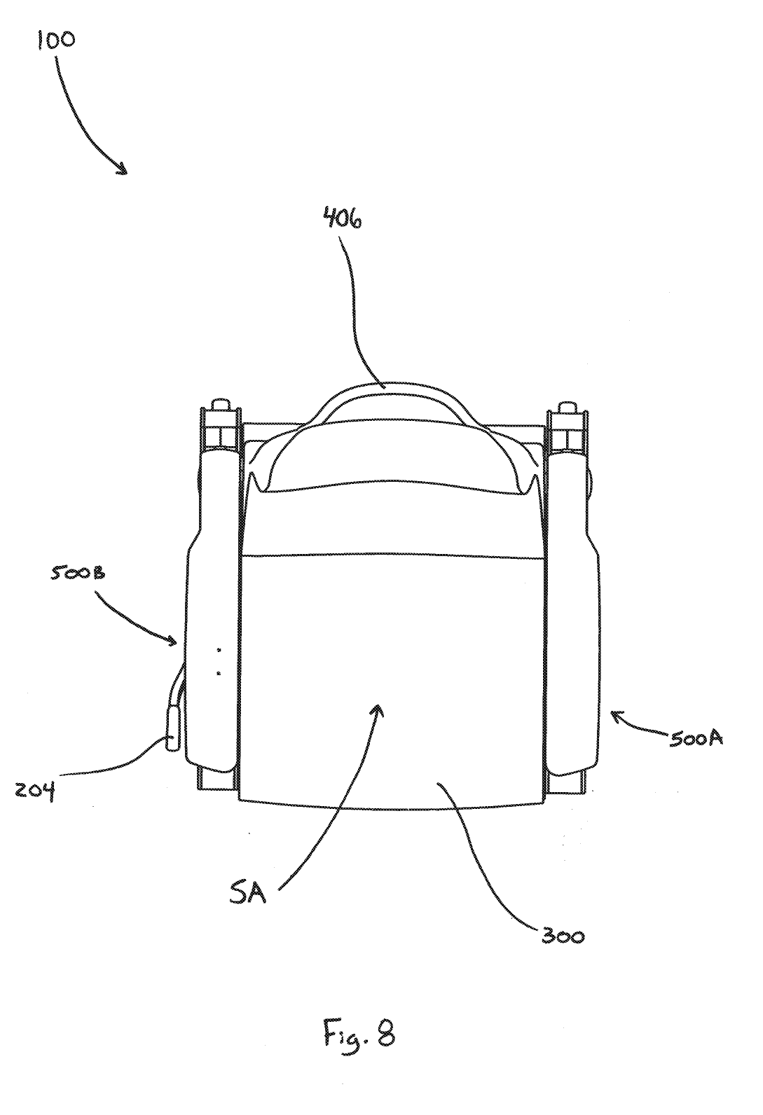

In some embodiments, free rotation of cantilever portion 502 from the down position to the upright position includes a transition of the cantilever portion 502 from a generally horizontal position (FIGS. 1 to 8) to a generally vertical position (FIGS. 9 to 14). As discussed above, in the horizontal (or down) position, arm rest assembly provides support for the arm of a seated user (or patient). In the vertical (or upright) position, the arm rest remains free from interfering with a user's access to the seating area SA such that a user is free to enjoy unobstructed side access to and from the seating area SA.

In some embodiments, the arm rest assembly 500 also includes a back support portion reclining lever 508 which may be utilized to adjust the position of the back support portion 400 relative to the seat bottom portion 300. For example, referring back to FIG. 16, a back support portion lever 512 is incorporated in cantilever portion 502 such that a seated user may easily and efficiently recline back support portion 400 by activating back support portion reclining lever 512.

Referring now to FIGS. 25B and 25C, cantilever portion 502 includes a back support portion lever aperture 1222, through which back support portion reclining lever 512 extends. In some embodiments, an interior of cantilever portion 502 (illustrated in FIG. 25C) includes a plurality of mounting features for securing back support portion reclining lever 512 to cantilever portion 502. For example, the interior of cantilever portion 502 includes back support portion reclining lever retaining features 1224 (such as back support portion reclining lever retaining features 1224A and 1224B). In some embodiments, back support portion reclining lever 512 is mounted to cantilever portion 502 via back support portion reclining lever retaining features 1224. In some embodiments, back support portion reclining lever 512 is attached to (or otherwise associated with) a back support portion reclining cable (not shown) which extends through arm rest assembly 500 and mechanically links the back support portion 400 to the back support portion reclining lever 512. In some embodiments, the back support portion reclining cable extends from back support portion reclining lever 512 through the arm rest assembly and into chair base 200 to mechanically link and cause reclining of back support portion 400 upon activation of back support portion reclining lever 512.

Various modifications and additions can be made to the embodiments discussed without departing from the scope of invention. For example, while the embodiments described above refer to particular features, the scope of invention includes embodiments having different combinations of features and embodiments that do not include all of the above described features.

The following is claimed:

1. A chair including:
a chair base having a forward end and a back end;
a seating portion secured to the chair base;
a back support portion having a forward side and a back side, the forward side configured to support a back of a user seated in the chair; and
a plurality of arm rest assemblies secured to the chair base, a first one of the arm rest assemblies including:
a pivot half, the pivot half including a forward end and a back end, the pivot half being secured to the chair base such that the forward side of the back support is closer to the forward end of the chair than the forward end of the pivot half is to the forward end of the chair, and
a cantilever portion extending from the pivot half toward the forward end of the chair base.

2. The chair of claim 1, wherein the cantilever portion of the first arm rest assembly is configured to transition between a down position and an upright position.

3. The chair of claim 2, wherein the first arm rest assembly includes a pivot activation feature, which when engaged, provides for transition of the cantilever portion of the first arm rest assembly to transition between said down and upright positions.

4. The chair of claim 3, wherein the pivot activation feature of the first arm rest assembly, when disengaged, provides for securing the cantilever portion of said arm rest assembly at each of said down and upright positions.

5. The chair of claim 4, wherein the cantilever portion is operable to rotate a designated number of degrees when transitioning between the upright position and the down position, where in the designated number of degrees is within the range of 85 to 90 degrees.

6. The chair of claim 3, wherein when the cantilever portion is positioned in the upright position, the forward side of the back support portion is closer to the forward end of the chair base than the cantilever portion is to the forward end of the chair base, and when the cantilever portion is positioned in the down position, the cantilever portion is closer to the forward end of the chair base than the forward side of the back support portion is to the forward end of the chair base.

7. The chair of claim 2, wherein a seating area is bound at least by the back support the seating portion and the plurality of arm rest assemblies, the seating area including at least a volume of space situated longitudinally between the back support and the forward end of the chair base, laterally between the arm rest assembles, and vertically between a top surface of the seating portion and an upper portion of the back support portion.

8. The chair of claim 7, wherein the top surface of the seating portion is situated below the cantilever portion of the first arm rest assembly, and the upper portion of the back support portion is situated above the cantilever portion of the first arm rest assembly.

9. The chair of claim 7, wherein the seated user is provided unobstructed side access to and from the seating area when the cantilever portion is positioned in the upright position, and wherein side access to and from the seating area is obstructed when the cantilever portion is positioned in the down position.

10. The chair of claim 7, wherein each arm rest assembly of the plurality of arm rest assemblies includes a cantilever portion configured to transition between a down position and an upright position such that the seated user is provided unobstructed side access to and from the seating area when the cantilever portion is positioned in the upright position, and wherein side access to and from the seating area is obstructed when the cantilever portion is positioned in the down position.

11. The chair of claim 1, wherein the first arm rest assembly further includes a back support portion reclining lever configured to provide for reclining of the back rest support portion.

12. The chair of claim 1, wherein the first arm rest assembly includes a plurality of pivot halves, the cantilever portion pivotably coupled to the plurality of pivot halves to form the arm rest assembly.

13. A chair arm rest assembly including:
a plurality of pivot halves including a first pivot half and a second pivot half, each of said first and second pivot halves including:
a mounting portion which provides for securing said pivot half to a chair base of a chair; and
a housing including:
a plurality of apertures; and
a fulcrum feature;
a cantilever portion pivotably coupled to each of the first pivot half and the second pivot half, the cantilever portion including an upright position aperture and a down position aperture; and
a pivot activation feature pivotably coupled to the fulcrum feature of the housing of the first pivot half, the pivot activation feature including an arm rest position securing feature adapted to be received by a first one of the plurality of apertures of the housing of the first pivot half and each of the upright and down position apertures of the cantilever portion, wherein when positioned in an engaged state, the pivot activation feature prevents pivoting of the cantilever portion between upright and down positions, and wherein when positioned in a disengaged state, the pivot activation feature provides for pivoting of the cantilever portion between upright and down positions.

14. The arm rest assembly of claim 13, wherein when the cantilever portion is positioned in the down position and the pivot activation feature is positioned in the engaged state, the arm rest position securing feature is received by each of the first aperture of the housing of the first pivot half and the down position aperture of the cantilever portion, thereby preventing the cantilever portion from transitioning to the upright position.

15. The arm rest assembly of claim 13, wherein when the cantilever portion is positioned in the down position and the pivot activation feature is positioned in the disengaged state, the arm rest position securing feature is free from each of the upright and down position apertures of the cantilever portion, thereby permitting the cantilever portion to transition to the upright position.

16. The arm rest assembly of claim 13, wherein when the cantilever portion is positioned in the upright position and the pivot activation feature is positioned in the engaged state, the arm rest position securing feature is received by each of the first aperture of the housing of the first pivot half and the upright position aperture of the cantilever portion, thereby preventing the cantilever portion from transitioning to the down position.

17. The arm rest assembly of claim 13, wherein when the cantilever portion is positioned in the upright position and the pivot activation feature is positioned in the disengaged state, the arm rest position securing feature is free from each of the upright and the down position apertures of the cantilever portion, thereby permitting the cantilever portion to transition to the down position.

18. The arm rest assembly of claim 13, further including a first wafer and a second wafer, the first wafer being coupled to the cantilever portion and situated between the cantilever portion and the first pivot half, the second wafer being coupled to the cantilever portion and situated between the cantilever portion and the second pivot half.

19. The arm rest assembly of claim 18, wherein when transitioning between the down and upright positions, the cantilever portion and the first and second wafers rotate relative to the first and second pivot halves.

20. The arm rest assembly of claim 19, wherein the first and second wafers remain fixed relative to the cantilever portion when transitioning the cantilever portion between down and upright positions.
